(19) United States
(12) Patent Application Publication
(10) Pub. No.: US 2026/0086762 A1
(43) Pub. Date: Mar. 26, 2026

(54) SYSTEM AND METHOD OF SPATIAL AUDIO SYNCHRONIZATION BETWEEN MULTIPLE DEVICES

(71) Applicant: Apple Inc., Cupertino, CA (US)

(72) Inventors: Finnegan N. SINCLAIR, Seattle, WA (US); Elena J. NATTINGER, Menlo Park, CA (US); Luis R. DELIZ CENTENO, Fremont, CA (US)

(21) Appl. No.: 19/295,425

(22) Filed: Aug. 8, 2025

Related U.S. Application Data
(60) Provisional application No. 63/699,796, filed on Sep. 26, 2024.
(60) Provisional application No. 63/740,016, filed on Dec. 30, 2024.

(51) Int. Cl. G06F 3/16; G06T 17/00

(52) U.S. Cl. CPC G06F 3/16; G06T 17/00

(57) ABSTRACT

An electronic device displays visual content at a first electronic device. Spatial audio is generated and aligned to simulate from visual content displayed in a physical environment using a first orientation vector from a first electronic device and a visual content location. The electronic device then transmits the spatial audio related to the virtual content for playback via one or more first audio output devices at the second electronic device at a respective location in the physical environment. The respective location corresponds to the virtual content location. In some examples, a second orientation vector is tracked either at the electronic device or at the second electronic device and is used to help generate and transmit the spatial audio.

### CROSS-REFERENCE TO RELATED APPLICATIONS

This application claims the benefit of U.S. Provisional Application No. 63/740,016, filed Dec. 30, 2024, and U.S. Provisional Application No. 63/699,796, filed Sep. 26, 2024, the contents of which are herein incorporated by reference in their entireties for all purposes.

### FIELD OF THE DISCLOSURE

This relates generally to systems and methods of spatial audio synchronization between multiple devices.

### BACKGROUND OF THE DISCLOSURE

Spatial audio provides a user with an audio experience that sounds as though audio is emitted from a location in an environment. In some examples, spatial audio related to virtual media content is aligned to be simulated from the same location in a physical environment from which the visual content is being displayed to a user.

### SUMMARY OF THE DISCLOSURE

Some examples of the disclosure are directed to systems and methods for synchronization of visual content with spatial audio between multiple devices. For example, the method comprises an electronic device (e.g., a mobile device) configured to communicate with a first electronic device (e.g., a head mounted device) including one or more displays to display visual content and a second electronic device (e.g., headphones or earphones) including one or more audio output devices to play spatial audio related to the visual content. In some examples, while transmitting the visual content to the first electronic device, the electronic device generates the spatial audio related to the visual content based on a first orientation vector of the first electronic device and a visual content location of the visual content within a virtual environment presented using the first electronic device. In some examples, the electronic device transmits the spatial audio related to the visual content to the second electronic device for playback of the spatial audio at the one or more audio output devices simulating that the spatial audio is playing from a respective location. In some examples, in accordance with a determination that the visual content location is a first location in the virtual environment, the respective location is associated with the first location in the virtual environment. In some examples, in accordance with a determination that the visual content location is a second location in the virtual environment different from the first location in the virtual environment, the respective location is associated with the second location in the virtual environment.

As another example, the system comprises a first electronic device configured to display visual content at a visual content location via one or more displays. In some examples, the system further comprises a second electronic device configured to play spatial audio related to the visual content via one or more audio output devices. In some examples, the system further comprises a third electronic device configured to transmit the spatial audio related to the visual content to the second electronic device for playback of the spatial audio at the one or more audio output devices simulating that the spatial audio is playing from a respective location. In some examples, in accordance with a determination that the visual content location is a first location in the virtual environment, the respective location is associated with the first location in the virtual environment. In some examples, in accordance with a determination that the visual content location is a second location in the virtual environment different from the first location in the virtual environment, the respective location is associated with the second location in the virtual environment.

The full descriptions of these examples are provided in the Drawings and the Detailed Description, and it is understood that this Summary does not limit the scope of the disclosure in any way.

### BRIEF DESCRIPTION OF THE DRAWINGS

For improved understanding of the various examples described herein, reference should be made to the Detailed Description below along with the following drawings. Like reference numerals often refer to corresponding parts throughout the drawings.

FIG. 1 illustrates an electronic device presenting an extended reality environment according to some examples of the disclosure.

FIGS. 2A-2B illustrate block diagrams of example architectures for electronic devices according to some examples of the disclosure.

FIG. 3 illustrates spatial audio playing at one or more locations in a three-dimensional environment according to some examples of the disclosure.

FIGS. 4A-4C illustrate a user listening to playback of spatial audio on different devices according to some examples of the disclosure.

FIGS. 5A and 5B illustrate the top view of an example three-dimensional environment according to some examples of the disclosure.

FIG. 6A is a block diagram illustrating an exchange of information between a head-mounted device and earphones according to some examples of the disclosure.

FIG. 6B is a block diagram illustrating an exchange of information between a head-mounted device, earphones, and a mobile device according to some examples of the disclosure.

FIGS. 7A-7B illustrate playback of spatial audio, generated by a mobile device, at one or more locations on a head-mounted device and transferring playback of the spatial audio to earphones according to some examples of the disclosure.

FIG. 8A-8C are flow diagrams illustrating example methods and criteria for handoff and synchronization of spatial audio between multiple devices according to some examples of the disclosure.

FIG. 9 is another example flow diagram illustrating example methods for handoff and synchronization of spatial audio between multiple devices according to some examples of the disclosure.

FIG. 10A illustrates an example of a head-mounted device 1001 (e.g., first electronic device) displaying visual content 1002 to a user and a glyph of an exemplary system.

FIG. 10B illustrates the system 1000 being utilized by a user in a three-dimensional environment 1004.

FIG. 10C illustrates the devices of the system 1000 in a three-dimensional environment 1004.

FIG. 11A illustrates the head-mounted device displaying visual content 1002 in visual content location 1003 after the head-mounted device has moved in the three-dimensional environment 1004.

FIG. 11B illustrates a bird's eye view of the same three-dimensional environment 1004 as FIG. 10C but the head-mounted device has moved in the physical environment.

FIG. 12 is a block diagram illustrating an example block diagram that illustrates the communication between a system 1200 corresponding to system 1000.

FIG. 13 is an example flow diagram illustrating an example process for synchronization of visual content to spatial audio between multiple devices according to some examples of the disclosure.

### DETAILED DESCRIPTION

In the following description of examples, reference is made to the accompanying drawings which form a part hereof, and in which it is shown by way of illustration specific examples that can be practiced. It is to be understood that other examples can be used and structural changes can be made without departing from the scope of the disclosed examples.

Some examples of the disclosure are directed to systems and methods for synchronization of visual content with spatial audio between multiple devices. For example, the method comprises an electronic device (e.g., a mobile device) configured to communicate with a first electronic device (e.g., a head mounted device) including one or more displays to display visual content and a second electronic device (e.g., headphones or earphones) including one or more audio output devices to play spatial audio related to the visual content. In some examples, while transmitting the visual content to the first electronic device, the electronic device generates the spatial audio related to the visual content based on a first orientation vector of the first electronic device and a visual content location of the visual content within a virtual environment presented using the first electronic device. In some examples, the electronic device transmits the spatial audio related to the visual content to the second electronic device for playback of the spatial audio at the one or more audio output devices simulating that the spatial audio is playing from a respective location. In some examples, in accordance with a determination that the visual content location is a first location in the virtual environment, the respective location is associated with the first location in the virtual environment. In some examples, in accordance with a determination that the visual content location is a second location in the virtual environment different from the first location in the virtual environment, the respective location is associated with the second location in the virtual environment.

As another example, the system comprises a first electronic device configured to display visual content at a visual content location via one or more displays. In some examples, the system further comprises a second electronic device configured to play spatial audio related to the visual content via one or more audio output devices. In some examples, the system further comprises a third electronic device configured to transmit the spatial audio related to the visual content to the second electronic device for playback of the spatial audio at the one or more audio output devices simulating that the spatial audio is playing from a respective location. In some examples, in accordance with a determination that the visual content location is a first location in the virtual environment, the respective location is associated with the first location in the virtual environment. In some examples, in accordance with a determination that the visual content location is a second location in the virtual environment different from the first location in the virtual environment, the respective location is associated with the second location in the virtual environment.

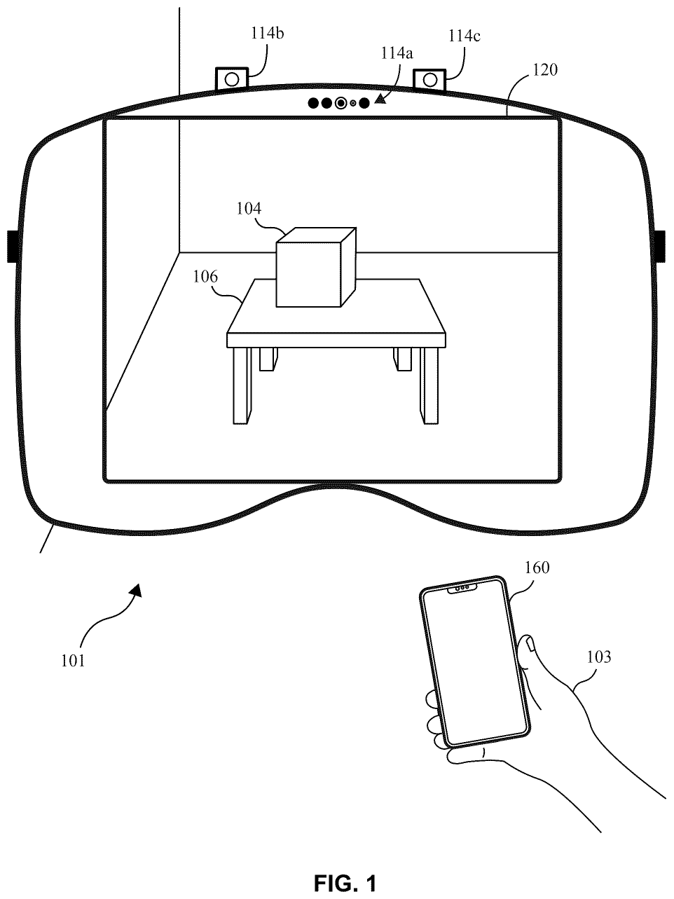

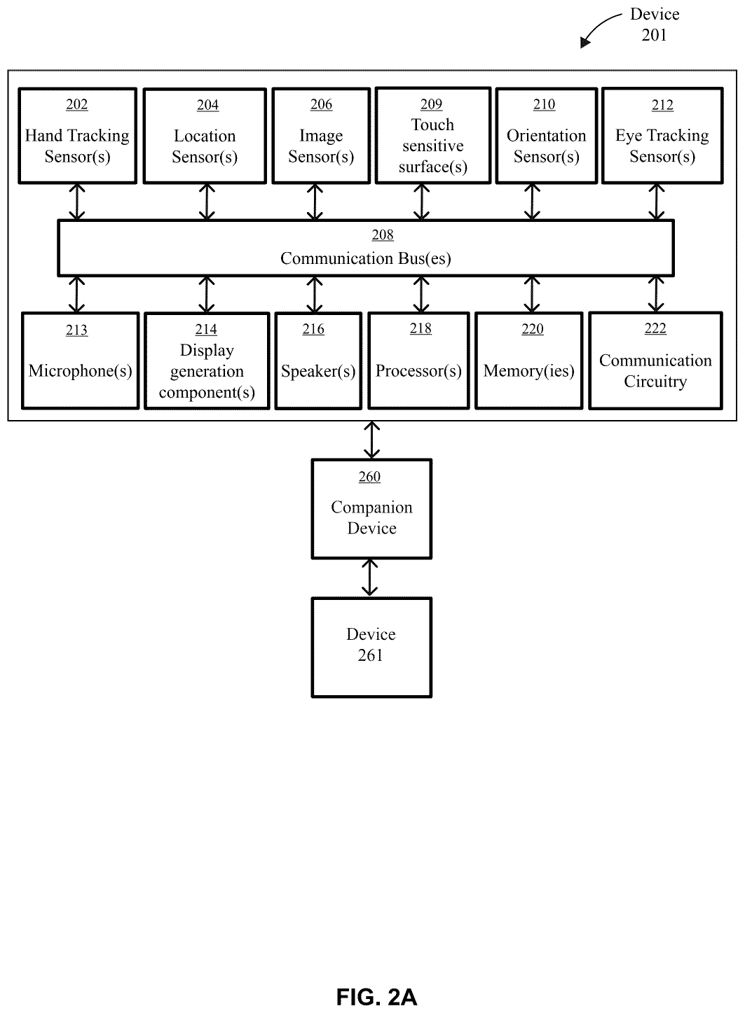

FIG. 1 illustrates an electronic device 101 presenting an extended reality (XR) environment (e.g., a computer-generated environment optionally including representations of physical and/or virtual objects) according to some examples of the disclosure. In some examples, as shown in FIG. 1, electronic device 101 is a head-mounted display or other head-mountable device configured to be worn on a head of a user of the electronic device 101. Examples of electronic device 101 are described below with reference to the architecture block diagram of FIG. 2A. As shown in FIG. 1, electronic device 101 and table 106 are located in a physical environment. The physical environment may include physical features such as a physical surface (e.g., floor, walls) or a physical object (e.g., table, lamp, etc.). In some examples, electronic device 101 may be configured to detect and/or capture images of physical environment including table 106 (illustrated in the field of view of electronic device 101).

In some examples, as shown in FIG. 1, electronic device 101 includes one or more internal image sensors 114a oriented towards a face of the user (e.g., eye tracking cameras described below with reference to FIGS. 2A-2B). In some examples, internal image sensors 114a are used for eye tracking (e.g., detecting a gaze of the user). Internal image sensors 114a are optionally arranged on the left and right portions of display 120 to enable eye tracking of the user's left and right eyes. In some examples, electronic device 101 also includes external image sensors 114b and 114c facing outwards from the user to detect and/or capture the physical environment of the electronic device 101 and/or movements of the user's hands or other body parts.

In some examples, display 120 has a field of view visible to the user (e.g., that may or may not correspond to a field of view of external image sensors 114b and 114c). Because display 120 is optionally part of a head-mounted device, the field of view of display 120 is optionally the same as or similar to the field of view of the user's eyes. In other examples, the field of view of display 120 may be smaller than the field of view of the user's eyes. In some examples, electronic device 101 may be an optical see-through device in which display 120 is a transparent or translucent display through which portions of the physical environment may be directly viewed. In some examples, display 120 may be included within a transparent lens and may overlap all or only a portion of the transparent lens. In other examples, electronic device may be a video-passthrough device in which display 120 is an opaque display configured to display images of the physical environment captured by external image sensors 114b and 114c. While a single display 120 is shown, it should be appreciated that display 120 may include a stereo pair of displays.

In some examples, in response to a trigger, the electronic device 101 may be configured to display a virtual object 104 in the XR environment represented by a cube illustrated in FIG. 1, which is not present in the physical environment, but is displayed in the XR environment positioned on the top of real-world table 106 (or a representation thereof). Optionally, virtual object 104 can be displayed on the surface of the table 106 in the XR environment displayed via the display 120 of the electronic device 101 in response to detecting the planar surface of table 106 in the physical environment 100.

It should be understood that virtual object 104 is a representative virtual object and one or more different virtual objects (e.g., of various dimensionality such as two-dimensional or other three-dimensional virtual objects) can be included and rendered in a three-dimensional XR environment. For example, the virtual object can represent an application, or a user interface displayed in the XR environment. In some examples, the virtual object can represent content corresponding to the application and/or displayed via the user interface in the XR environment. In some examples, the virtual object 104 is optionally configured to be interactive and responsive to user input (e.g., air gestures, such as air pinch gestures, air tap gestures, and/or air touch gestures), such that a user may virtually touch, tap, move, rotate, or otherwise interact with, the virtual object 104.

In some examples, the electronic device 101 may be configured to communicate with a second electronic device, such as a companion device. For example, as illustrated in FIG. 1, the electronic device 101 may be in communication with electronic device 160. In some examples, the electronic device 160 corresponds to a mobile electronic device, such as a smartphone, a tablet computer, a smart watch, or other electronic device. Additional examples of electronic device 160 are described below with reference to the architecture block diagram of FIG. 2B. In some examples, the electronic device 101 and the electronic device 160 are associated with a same user. For example, in FIG. 1, the electronic device 101 may be positioned (e.g., mounted) on a head of a user and the electronic device 160 may be positioned near electronic device 101, such as in a hand 103 of the user (e.g., the hand 103 is holding of the electronic device 160), and the electronic device 101 and the electronic device 160 are associated with a same user account of the user (e.g., the user is logged into the user account on the electronic device 101 and the electronic device 160). Additional details regarding the communication between the electronic device 101 and the electronic device 160 are provided below with reference to FIGS. 2A-2B.

In some examples, displaying an object in a three-dimensional environment may include interaction with one or more user interface objects in the three-dimensional environment. For example, initiation of display of the object in the three-dimensional environment can include interaction with one or more virtual options/affordances displayed in the three-dimensional environment. In some examples, a user's gaze may be tracked by the electronic device as an input for identifying one or more virtual options/affordances targeted for selection when initiating display of an object in the three-dimensional environment. For example, gaze can be used to identify one or more virtual options/affordances targeted for selection using another selection input. In some examples, a virtual option/affordance may be selected using hand-tracking input detected via an input device in communication with the electronic device. In some examples, objects displayed in the three-dimensional environment may be moved and/or reoriented in the three-dimensional environment in accordance with movement input detected via the input device.

In the discussion that follows, an electronic device that is in communication with a display generation component and one or more input devices is described. It should be understood that the electronic device optionally is in communication with one or more other physical user-interface devices, such as a touch-sensitive surface, a physical keyboard, a mouse, a joystick, a hand tracking device, an eye tracking device, a stylus, etc. Further, as described above, it should be understood that the described electronic device, display and touch-sensitive surface are optionally distributed amongst two or more devices. Therefore, as used in this disclosure, information displayed on the electronic device or by the electronic device is optionally used to describe information outputted by the electronic device for display on a separate display device (touch-sensitive or not). Similarly, as used in this disclosure, input received on the electronic device (e.g., touch input received on a touch-sensitive surface of the electronic device, or touch input received on the surface of a stylus) is optionally used to describe input received on a separate input device, from which the electronic device receives input information.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, a television channel browsing application, and/or a digital video player application. One or more of the devices described herein support playback of spatial audio (e.g., for media application such as for music, television, or video application).

FIGS. 2A-2B illustrate block diagrams of example architectures for electronic devices 201 and 260 according to some examples of the disclosure. In some examples, electronic device 201 and/or electronic device 260 include one or more electronic devices. For example, the electronic device 201 may be a portable device, an auxiliary device in communication with another device, a head-mounted display, etc., respectively. In some examples, electronic device 201 corresponds to electronic device 101 described above with reference to FIG. 1. In some examples, electronic device 260 corresponds to electronic device 160 described above with reference to FIG. 1.

As illustrated in FIG. 2A, the electronic device 201 optionally includes various sensors, such as one or more hand tracking sensors 202, one or more location sensors 204A, one or more image sensors 206A (optionally corresponding to internal image sensors 114a and/or external image sensors 114b and 114c in FIG. 1), one or more touch-sensitive surfaces 209A, one or more motion and/or orientation sensors 210A, one or more eye tracking sensors 212, one or more microphones 213A or other audio sensors, one or more body tracking sensors (e.g., torso and/or head tracking sensors), one or more display generation components 214A, optionally corresponding to display 120 in FIG. 1, one or more speakers 216A, one or more processors 218A, one or more memories 220A, and/or communication circuitry 222A. One or more communication buses 208A are optionally used for communication between the above-mentioned components of electronic devices 201. Additionally, as shown in FIG. 2B, the electronic device 260 optionally includes one or more location sensors 204B, one or more image sensors 206B, one or more touch-sensitive surfaces 209B, one or more orientation sensors 210B, one or more microphones 213B, one or more display generation components 214B, one or more speakers 216B, one or more processors 218B, one or more memories 220B, and/or communication circuitry 222B. One or more communication buses 208B are optionally used for communication between the above-mentioned components of electronic device 260. The electronic devices 201, 260, are optionally configured to communicate via a wired or wireless connection (e.g., via communication circuitry 222A, 222B) between the two electronic devices. For example, as indicated in FIG. 2A, the electronic device 260 may function as a companion device to the electronic device 201.

Communication circuitry 222A, 222B optionally includes circuitry for communicating with electronic devices, networks, such as the Internet, intranets, a wired network and/or a wireless network, cellular networks, and wireless local area networks (LANs). Communication circuitry 222A, 222B optionally includes circuitry for communicating using near-field communication (NFC) and/or short-range communication, such as Bluetooth®.

One or more processors 218A, 218B include one or more general processors, one or more graphics processors, and/or one or more digital signal processors. In some examples, memory 220A or 220B is a non-transitory computer-readable storage medium (e.g., flash memory, random access memory, or other volatile or non-volatile memory or storage) that stores computer-readable instructions configured to be executed by one or more processors 218A, 218B to perform the techniques, processes, and/or methods described below. In some examples, memory 220A and/or 220B can include more than one non-transitory computer-readable storage medium. A non-transitory computer-readable storage medium can be any medium (e.g., excluding a signal) that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on compact disc (CD), digital versatile disc (DVD), or Blu-ray technologies, as well as persistent solid-state memory such as flash, solid-state drives, and the like.

In some examples, one or more display generation components 214A, 214B include a single display (e.g., a liquid-crystal display (LCD), organic light-emitting diode (OLED), or other types of display). In some examples, one or more display generation components 214A, 214B includes multiple displays. In some examples, one or more display generation components 214A, 214B can include a display with touch capability (e.g., a touch screen), a projector, a holographic projector, a retinal projector, a transparent or translucent display, etc. In some examples, electronic devices 201 and 260 include one or more touch-sensitive surfaces 209A and 209B, respectively, for receiving user inputs, such as tap inputs and swipe inputs or other gestures. In some examples, one or more display generation components 214A, 214B and one or more touch-sensitive surfaces 209A, 209B form one or more touch-sensitive displays (e.g., a touch screen integrated with each of electronic devices 201 and 260 or external to each of electronic devices 201 and 260 that are in communication with each of electronic devices 201 and 260).

Electronic devices 201 and 260 optionally one or more includes image sensors 206A and 206B, respectively. The one or more image sensors 206A, 206B optionally include one or more visible light image sensors, such as charged coupled device (CCD) sensors, and/or complementary metal-oxide-semiconductor (CMOS) sensors operable to obtain images of physical objects from the real-world environment. The one or more image sensors 206A, 206B also optionally include one or more infrared (IR) sensors, such as a passive or an active IR sensor, for detecting infrared light from the real-world environment. For example, an active IR sensor includes an IR emitter for emitting infrared light into the real-world environment. The one or more image sensors 206A, 206B also optionally include one or more cameras configured to capture movement of physical objects in the real-world environment. The one or more image sensors 206A, 206B also optionally include one or more depth sensors configured to detect the distance of physical objects from electronic device 201, 260. In some examples, information from one or more depth sensors can allow the device to identify and differentiate objects in the real-world environment from other objects in the real-world environment. In some examples, one or more depth sensors can allow the device to determine the texture and/or topography of objects in the real-world environment.

In some examples, electronic device 201, 260 uses CCD sensors, event cameras, and depth sensors in combination to detect the physical environment around electronic device 201, 260. In some examples, one or more image sensors 206A, 206B include a first image sensor and a second image sensor. The first image sensor and the second image sensor work in tandem and are optionally configured to capture different information of physical objects in the real-world environment. In some examples, the first image sensor is a visible light image sensor, and the second image sensor is a depth sensor. In some examples, electronic device 201, 260 uses image one or more sensors 206A, 206B to detect the position and orientation of electronic device 201, 260 and/or one or more display generation components 214A, 214B in the real-world environment. For example, electronic device 201, 260 uses one or more image sensors 206A, 206B to track the position and orientation of one or more display generation components 214A, 214B relative to one or more fixed objects in the real-world environment.

In some examples, electronic devices 201 and 260 include one or more microphones 213A and 213B, respectively, or other audio sensors. Electronic device 201, 260 optionally uses one or more microphones 213A, 213B to detect sound from the user and/or the real-world environment of the user. In some examples, one or more microphones 213A, 213B includes an array of microphones (a plurality of microphones) that optionally operate in tandem, such as to identify ambient noise or to locate the source of sound in space of the real-world environment.

Electronic devices 201 and 260 include one or more location sensors 204A and 204B, respectively, for detecting a location of electronic device 201A and/or one or more display generation components 214A and a location of electronic device 260 and/or one or more display generation components 214B, respectively. For example, one or more location sensors 204A, 204B can include a global positioning system (GPS) receiver that receives data from one or more satellites and allows electronic device 201, 260 to determine the device's absolute position in the physical world.

Electronic devices 201 and 260 include one or more orientation sensors 210A and 210B, respectively, for detecting orientation and/or movement of electronic device 201 and/or one or more display generation components 214A and orientation and/or movement of electronic device 260 and/or one or more display generation components 214B, respectively. For example, electronic device 201, 260 uses one or more orientation sensors 210A, 210B to track changes in the position and/or orientation of electronic device 201, 260 and/or one or more display generation components 214A, 214B, such as with respect to physical objects in the real-world environment. One or more orientation sensors 210A, 210B optionally include one or more gyroscopes and/or one or more accelerometers.

Electronic device 201 includes one or more hand tracking sensors 202 and/or one or more eye tracking sensors 212 (and/or one or more other body tracking sensors, such as leg, torso and/or head tracking sensors), in some examples. One or more hand tracking sensors 202 are configured to track the position/location of one or more portions of the user's hands, and/or motions of one or more portions of the user's hands with respect to the extended reality environment, relative to the one or more display generation components 214A, and/or relative to another defined coordinate system. One or more eye tracking sensors 212 are configured to track the position and movement of a user's gaze (eyes, face, or head, more generally) with respect to the real-world or extended reality environment and/or relative to the one or more display generation components 214A. In some examples, one or more hand tracking sensors 202 and/or one or more eye tracking sensors 212 are implemented together with the one or more display generation components 214A. In some examples, the one or more hand tracking sensors 202 and/or one or more eye tracking sensors 212 are implemented separate from the one or more display generation components 214A. In some examples, electronic device 201 alternatively does not include one or more hand tracking sensors 202 and/or one or more eye tracking sensors 212. In some such examples, the one or more display generation components 214A may be utilized by the electronic device 260 to provide an extended reality environment and utilize input and other data gathered via the one or more other sensors (e.g., the one or more location sensors 204A, one or more image sensors 206A, one or more touch-sensitive surfaces 209A, one or more motion and/or orientation sensors 210A, and/or one or more microphones 213A or other audio sensors) of the electronic device 201 as input and data that is processed by the one or more processors 218B of the electronic device 260. Additionally or alternatively, electronic device 201 optionally does not include other components shown in FIG. 2B, such as location sensors 204B, image sensors 206B, touch-sensitive surfaces 209B, etc. In some such examples, the one or more display generation components 214A may be utilized by the electronic device 260 to provide an extended reality environment and the electronic device 260 utilize input and other data gathered via the one or more motion and/or orientation sensors 210A (and/or one or more microphones 213A) of the electronic device 201 as input.

In some examples, the one or more hand tracking sensors 202 (and/or one or more other body tracking sensors, such as leg, torso and/or head tracking sensors) can use one or more image sensors 206 (e.g., one or more IR cameras, three-dimensional cameras, depth cameras, etc.) that capture three-dimensional information from the real-world including one or more body parts (e.g., hands, legs, or torso of a human user). In some examples, the hands can be resolved with sufficient resolution to distinguish fingers and their respective positions. In some examples, one or more image sensors 206A are positioned relative to the user to define a field of view of the one or more image sensors 206A and an interaction space in which finger/hand position, orientation and/or movement captured by the image sensors are used as inputs (e.g., to distinguish from a user's resting hand or other hands of other persons in the real-world environment). Tracking the fingers/hands for input (e.g., gestures, touch, tap, etc.) can be advantageous in that tracking does not require the user to touch, hold or wear any sort of beacon, sensor, or other marker.

In some examples, one or more eye tracking sensors 212 includes at least one eye tracking camera (e.g., infrared (IR) cameras) and/or illumination sources (e.g., IR light sources, such as LEDs) that emit light towards a user's eyes. The eye tracking cameras may be pointed towards a user's eyes to receive reflected IR light from the light sources directly or indirectly from the eyes. In some examples, both eyes are tracked separately by respective eye tracking cameras and illumination sources, and a focus/gaze can be determined from tracking both eyes. In some examples, one eye (e.g., a dominant eye) is tracked by one or more respective eye tracking cameras/illumination sources.

Electronic devices 201 and 260 are not limited to the components and configuration of FIGS. 2A-2B, but can include fewer, other, or additional components in multiple configurations. In some examples, electronic device 201 and/or electronic device 260 can each be implemented between multiple electronic devices (e.g., as a system). In some such examples, each of (or more) electronic device may each include one or more of the same components discussed above, such as various sensors, one or more display generation components, one or more speakers, one or more processors, one or more memories, and/or communication circuitry. A person or persons using electronic device 201 and/or electronic device 260, is optionally referred to herein as a user or users of the device.

In some examples, electronic device 201 and/or 260 can be in communication with another electronic device. For example, FIG. 2A illustrates electronic device 261 in communication with electronic device 201 and companion devices 260. Electronic device 261 is not limited to the components and configuration of FIGS. 2A-2B, but can include fewer, other, or additional components in multiple configurations. In some examples, electronic device 261 can be implemented between multiple electronic devices (e.g., as a system). In some such examples, electronic device 261 may each include one or more of the same components discussed above, such as various sensors, one or more display generation components, one or more speakers, one or more processors, one or more memories, and/or communication circuitry. In some examples, electronic device 261 does not include image sensors 206A. In some examples, electronic device 261 does not include display generation components 214B (e.g., output devices may include speaker or haptics, but display functionality would require another electronic device). A person or persons using electronic device 261 is optionally referred to herein as a user or users of the device. Electronic device 261 may be an audio output device, such as headphones or earphones. In some examples, electronic device 260 may be configured to receive information from electronic devices 201 and 261 and perform computations that electronic devices 201 and 261 may be incapable of performing. Additionally, electronic devices 201, 260, and 261 may communicate between one another be transferring data back and forth.

In some examples, communication between electronic devices 201, 260, and 261 includes the transfer of spatial audio from a spatial audio generating device to a spatial audio playback device. In some examples, a mobile phone (e.g., electronic device 260) generates spatial audio that is transferred to a head-mounted device (e.g., electronic device 201) or earphones/earbuds (e.g., electronic device 261) for output. In other examples, a head mounted device generates spatial audio that is transferred to earphone or earbuds for output. Additionally or alternatively, motion and/or orientation information can be obtained by the spatial audio generating device to serve as a frame of reference for generating spatial audio to reflect movement of the head and/or body of the listener. Spatial audio can be transferred between electronic devices to be played from their respective audio outputs devices. For example, spatial audio can be transmitted from a mobile device to headphones or earphones to play the spatial audio. When a user transfers the spatial audio from a head-mounted device to earphones, the similar orientations of the two devices cause the spatial audio to play at the same location. In some examples, when there are two potential output devices for the spatial audio, there are potentially two places to send the spatial audio and obtain information concerning the device's orientation or frame of reference. The method herein aids in detecting a change of between the orientation of each output device to avoid spatial audio location source mismatch during the handoff between these device. The solution described herein tracks the orientation vectors of the devices and then uses the offset between the vectors to transfer the audio and play the audio at the new location relative to the second device's orientation and the offset between the vectors. This solution can benefit the user's overall audio experience by seamlessly switching between spatial audio outputs in an environment without lag or any other audio/technical issues.

Attention is now directed towards systems and methods for handoff and synchronization of spatial audio between devices based on an offset between the frame of references (e.g., location and/or orientation) of the devices, such as transferring the playback of spatial audio from a head-mounted device to headphones or earphones.

Some electronic devices are capable of outputting spatialized audio signals, in which audio content is processed to make the audio content sound, to a user of the electronic device, as though audio sources of the audio content are emanating from various simulated source locations in the environment around the user. As the user moves in the environment (e.g., locomotion and/or head rotation), the simulated source locations can sound to the user as remaining fixed in the environment. An electronic device generating the spatial audio can use a frame of reference, such as a reference orientation tracked by one or more sensors of the electronic device or another electronic device, to maintain the spatial audio as emanating from the simulated source locations. As described herein, in some examples, a first electronic device transfers and initiates playback of spatial audio at a second device in response to an indication to transfer the audio and a calculation of an offset between the orientation of the two devices.

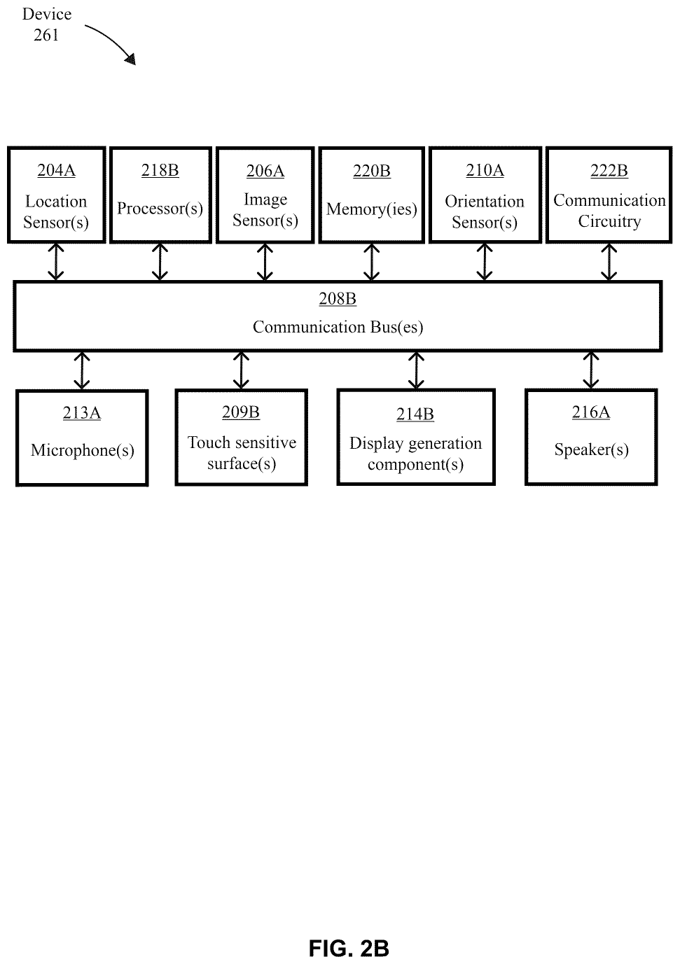

FIG. 3 illustrates an example of a first electronic device 101 worn by user 301 performing playback of a spatial audio at one or more first locations 302, 304, and 306 in a three-dimensional environment 300. It is understood that first locations 302, 304, and 306 are non-limiting representations of simulated source locations, and that more or fewer simulated source locations and/or a different distribution of locations within the three-dimensional environment are possible.

In some examples, the method described herein is performed at a first electronic device 101 in communication with one or more devices. First electronic device 101 can correspond to electronic device 201 or another device described herein that can generate spatial audio and output spatial audio to an audio output device. In some examples, first electronic device 101 is a head-mounted device. In some examples, first electronic device 101 may be a mobile device. First electronic device 101 includes one or more first audio output devices 308. The first electronic device 101 performs playback of the spatial audio via the one or more first audio output devices 308. In some examples, one or more first audio output devices 308 may be a speaker or a plurality of speakers attached internally or externally to first electronic device 101. In some examples, one or more first audio output devices 308 may be headphones or earbuds connected to first electronic device 101.

FIG. 3 depicts a bird-eye view of a three-dimensional environment 300, wherein the three-dimensional environment 300 is a physical environment. The first electronic device 101 plays the spatial audio at one or more first locations 302, 304, and 306 in the three-dimensional environment 300. The “X” marks represent the spatial audio locations 302-306 from which the audio sounds simulate being emanate from. In some examples, spatial audio sounds as though emanating from a subset of the one or more first locations (optionally from a single location). In some examples, some of the one or more first locations can be behind user 301, so spatial audio sounds as though emanating from behind the user 301. In some other examples, one or more first locations 302, 304, and 306 may be to the left of user 301, right of user 301 and/or in front of user 301, so spatial audio sounds as though emanating on both sides of user 301 simultaneously or separately. In some examples, the locations are limited to within the physical boundaries of the environment in which the user is located.

As described herein, in some examples, spatial audio may be playing on audio output devices 308 at one or more first locations 302, 304, and 306 from an application running on first electronic device 101. For example, the application can be a media application that is playing music, podcasts, audio books, videos or any other media that includes spatial audio. In some examples, the placements of the one or more first locations 302, 304, and 306 are relative to the to an initial pose (e.g., position and/or orientation) of first electronic device 101.

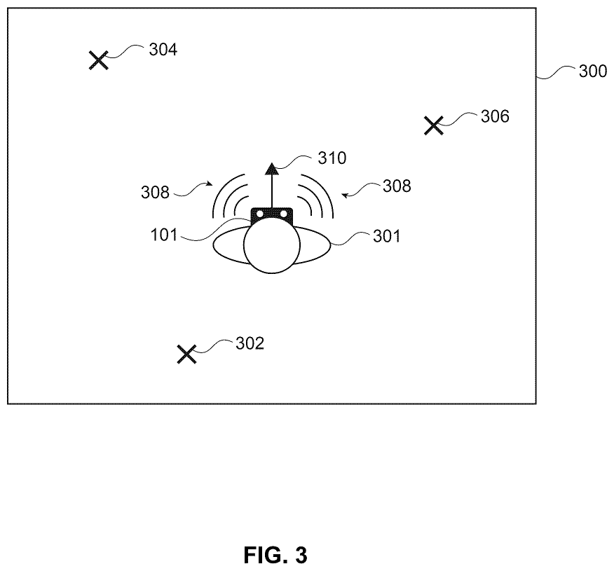

Furthermore, first electronic device 101 is optionally configurable to transfer spatial audio to another electronic device in three-dimensional environment 300 as described in more detail with respect to FIGS. 4A-4C.

In some examples, first electronic device 101 can generate (e.g., using depth and/or image sensors) or obtain (e.g., from memory) a representation of the three-dimensional environment 300. The representation of three-dimensional environment 300 is optionally a map of the environment. In some examples, the representation includes representations of objects in the three-dimensional environment 300 that optionally are accounted for in the generation of spatial audio.

In some examples, first electronic device 101 can use the representation of three-dimensional environment 300 and one or more input devices (e.g., depth and/or image sensors) to help determine a pose within the three-dimensional environment 300. In some examples, the placement of the locations from which spatial audio emanates is based on the representation of the three-dimensional environment 300. In some examples, the one or more first locations 302, 304, and 306 and the electronic devices used to generate and/or output the spatial audio are all within three-dimensional environment 300.

In some examples, first electronic device 101 may have a one or more cameras or other suitable optical or proximity sensors described herein to detect locations of the objects in the three-dimensional environment 300. In some examples, the one or more cameras enable improved audio spatialization based on locations of physical objects in the three-dimensional environment 300. For example, one or more cameras can be used to detect objects in the space and the generation of spatial audio can mimic the effects of the physical object on audio generated at the one or more first locations (e.g., objects may act as sound barriers, sound absorbers, sound reflectors, etc.).

Additionally or alternatively, one or more input devices, including motion and/or orientation sensors and/or camera, can be used to detect movement of the first electronic device 101. For example, the cameras can detect movement using changes in the images of the three-dimensional environment 300 captured by the camera. For example, when a user moves (e.g., locomotes) the first electronic device 101 to a different location in three-dimensional environment 300, the captured image can be compared with the representation of the three-dimensional environment 300 and/or prior captured images to determine a new location in the three-dimensional environment 300 or a change in position. Additionally or alternatively, the one or more cameras can detect changes in head rotation (e.g., pitch, yaw, or roll). Further, in some examples, first electronic device 101 includes one or more accelerometers to detect locomotion and/or head movement of the user.

In some examples, user 301 can move around three-dimensional environment 300 and the one or more first locations 302, 304, and 306 of spatial audio can relocate with the user. In other words, the one or more locations stay still relative to the three-dimensional environment 300 as the first electronic device 101 moves around the environment with user 301 and update relative to the user as the user moves in the three-dimensional environment 300. In some examples, user 301 moves around three-dimensional environment 300 without moving one or more first locations 302, 304, and 306 of spatial audio. For example, when a user 301 wears the first electronic device 101 (e.g., a head-mounted device), the first electronic device 101 continues playing spatial audio from one or more first locations 302, 304, and 306 while user 301 locomotes in three-dimensional environment 300. Maintaining the one or more first location is enabled by the first electronic device 101 (or another electronic device in communication with the first electronic device 101) tracking movement (e.g., using cameras and/or motion sensors as described above). In other words, the first electronic device 101 (or another electronic device in communication with the first electronic device 101) tracks movement to provide a frame of reference for the presentation of spatial audio. In some examples, the frame of reference is a “forward” orientation (or “front” orientation) of the first electronic device 101. The frame of reference for the spatial audio and initial placement of the one or more first location can be initiated from a reference pose (reference position and/or orientation). Changes in the position and/or orientation of the electronic device relative to the initial reference pose can be tracked to maintain spatial understanding of the electronic device/user with respect to the one or more first locations.

In some examples, one or more of the electronic devices in three-dimensional environment 300 track one or more frames of reference. In some examples, the electronic devices in three-dimensional environment 300 track respective frames of reference (e.g., a first electronic device tracks a first frame of reference, a second electronic device tracks a second frame of reference, etc.). In other examples, an electronic device optionally uses a frame of reference from another device for updating spatial audio. For example, a second frame of reference for a second electronic device in the environment is transferred to a first electronic device in the environment. An offset between the second frame of reference for the second electronic device and the first frame of reference for the first electronic device can be calculated and used by the first electronic device to present spatial audio using the second frame of reference for generating the spatial audio as described herein. In some examples, first electronic device 101 tracks its own frame of reference, which is optionally represented as a vector from a position of the device and/or with an offset from the fixed position of the device. The vector representing the frame of reference for first electronic device 101 is referred to herein as the first orientation vector 310. First orientation vector 310 can be a front facing from the first electronic device 101 (e.g., representing the forward direction for a person wearing a head-mounted device). In some examples, first orientation vector 310 originates from the center of first electronic device 101 and points forward. When first electronic device 101 is a head-mounted device, as shown in FIG. 3, then the first orientation vector 310 optionally originate from the center of the head of user 301 or center of the first electronic device 101. In some examples, the magnitude of first orientation vector 310 is not important, just the direction in which its points, representing what “forward” is to the first electronic device 101. As user 301 and first electronic device 101 move throughout three-dimensional environment 300 together, this direction changes. First electronic device 101 continues to play the spatial audio from the same one or more first locations 302, 304, and 306, even when first electronic device 101 is now in another location/position in three-dimensional environment 300. The change in direction of first orientation vector 310 is tracked and used to continue playing the spatial audio at the one or more first locations 302, 304, and 306 despite the change in direction of first orientation vector 310. In some examples, first orientation vector 310 is tracked continuously. In other examples, first orientation vector 310 is tracked periodically at intervals, in response to a trigger, when one or more criteria are satisfied, or the like. In some examples, the rate of tracking can be increased when spatial audio is playing or under conditions when playback of spatial audio is likely to begin.

FIGS. 4A-4C illustrate user 401 listening to playback of spatial audio on various devices in an ecosystem. The playback may be performed on multiple devices in a cluster, or one device in the ecosystem without other devices in the ecosystem. In some examples, the playback of spatial audio is transferred from the head-mounted device in FIG. 4A (e.g., first electronic device 101), to both devices (e.g., first electronic device 101 and second electronic device 410) in FIG. 4B, and/or to only the earphones (e.g., second electronic device 410) in FIG. 4C.

In some examples, first electronic device 101 is in communication with a second electronic device 410. Second electronic device 410 may correspond to electronic device 261 described herein. In other examples, second electronic device 410 may be any electronic device in the ecosystem of devices in three-dimensional environment 300. In some examples, second electronic device 410 may be an audio output device, such as headphones or earphones. In some examples, second electronic device 410 may be incapable of spatializing spatial audio on its own. In these examples, first electronic device 101 or another electronic device 260 may spatialize spatial audio and transfer the spatialized audio and/or data related to spatialized audio to the second electronic device 410. Second electronic device 410 includes one or more second audio output devices 412. In some examples, these second audio output devices may be the speakers on a set of earphones that are inserted into the ear of user 401. In some other examples, second audio output devices may be speakers on headphones or a headset. In some examples, second electronic device 410 does not sense data related to the three-dimensional environment; all the information the second electronic device receives, other than tracking its own frame of reference, is received from first electronic device 101. In some examples, second electronic device 410 does not need to have any knowledge of the three-dimensional environment when first electronic device 101 performs the socialization of the audio.

In FIG. 4A, first electronic device 101 is being worn by user 401 and is performing playback of spatial audio via the one or more first audio output devices 308. FIG. 4A illustrates the same example and user from FIG. 3, except illustrated from a front point of view. Second electronic device 410 is shown in the ecosystem in this figure and is in communication with first electronic device 101.

In some examples, while first electronic device 101 is performing playback of spatial audio via the one or more first audio output devices 308, the first electronic device 101 receives an indication to transfer spatial audio to the one or more second audio output devices 412 of second electronic device 410. This indication may be any sort of input, alert, or action that occurs that tells first electronic device 101 to switch the playback of spatial audio to another device in the ecosystem. In some examples, the indication is in response to detecting a user input or simply turning on the second electronic device 410 (e.g., donning the earphones). In some other examples, the indication may be that the second electronic device 410 was paired to the first electronic device 101 via Bluetooth. For example, the touch sensors on the earphones may sense that user 401 has put the earphones in their ears, which may also act as an indication to first electronic device 101 to transfer spatial audio. In response to receiving the indication to transfer spatial audio to the one or more second audio output devices 412, first electronic device 101 may transmit spatial audio to the second electronic device 410.

In FIG. 4B, a user 401 wears the head-mounted device as shown in 4A and has indicated to transfer the audio from the head-mounted device to the earphones (e.g., from the first electronic device 101 to the second electronic device 410). After the indication is received, spatial audio may be transferred and played through the one or more second audio output devices 412 of the second electronic device 410, or the earphones, without being played through one or more first audio output devices 308 of the first electronic device 101 (and optionally without being played through any other audio output devices other than second audio output devices 412 of the second electronic device 410). Though first electronic device 101 is sending the spatial audio to second electronic device 410 for playback, in some examples, first electronic device 101 will continue playing the spatial audio simultaneously. In other examples, the first electronic device 101 may initiate playback of spatial audio through the one or more second audio output devices 412 of second electronic device 410 and continue playback of spatial audio at the one or more first audio output devices 308 of first electronic device 101. For example, when a user 401 is wearing the head-mounted device (e.g., first electronic device 101), like in FIG. 4A, and then puts the earphones in their ear, this may be the indication to transfer spatial audio. Thus, the first electronic device 101 transfers playback of spatial audio to the earphones, or second electronic device 410. Spatial audio may play from both devices as shown in FIG. 4B, or through the earphones without the first electronic device 101, as shown in FIG. 4C. FIG. 4C illustrates the head-mounted device playing spatial audio from the earphones without playing spatial audio from the head-mounted device itself (or any other audio output device optionally).

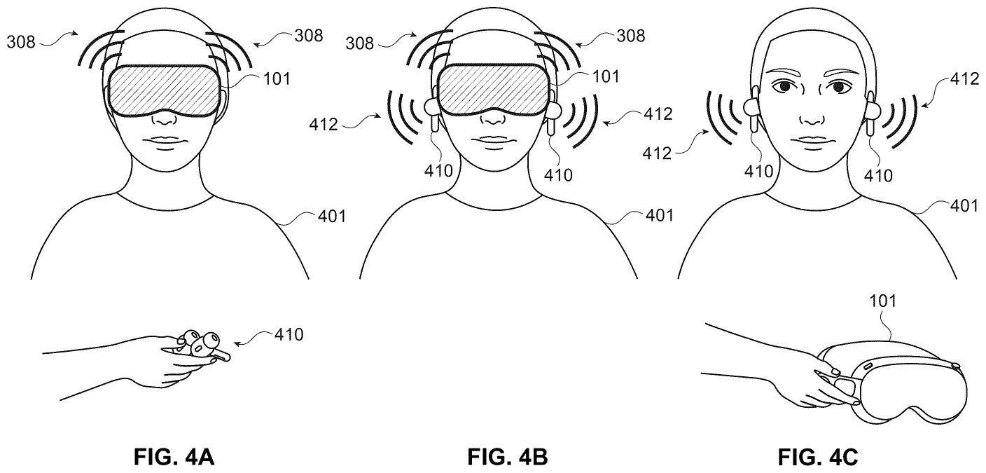

FIGS. 5A and 5B illustrate the top view of an example three-dimensional environment 500 for user 501. User 501 is optionally the same as user 401 shown in FIGS. 4A-4C and user 301 shown in FIG. 3. The figures show a user 501 wearing either multiple devices emanating spatial audio from one or more spatial locations (e.g., one or more second locations 502, 504, and 506) or a user 501 wearing the earphones (e.g., second electronic device 410) after the audio has been transferred from the head mounted device (e.g., first electronic device 101) without wearing the head mounted device. FIGS. 4A, 4B, and 4C correlate to FIGS. 3, 5A, and 5B, respectively.

In some examples, after the spatial audio transfer, as shown in FIGS. 5A and 4B, the user 501 may listen to the spatial audio at one or more second locations 502, 504, and 506 via the one or more first audio output devices 308 and the one or more second audio output devices 412 (e.g., playing from both first electronic device 101 and second electronic device 410). In some examples, after the spatial audio transfer, as shown in FIGS. 5B and 4C, user 501 may listen to the spatial audio at the one or more second locations 502, 504, and 506 via the one or more second audio output devices 412 (e.g., playing from the second electronic device 410 without playing from the first electronic device 101).

Similarly to how first electronic device 101 periodically tracks its own first orientation vector 310, the second electronic device 410 constantly tracks, or updates, a second orientation vector 508. Second orientation vector 508 performs the same as first orientation vector 310, but instead tracks the frame of reference of the second electronic device 410 (e.g., what is the second electronic device's “front”). In some examples, second orientation vector 508 originates from the center of second electronic device 410 and points towards the forward direction of the second electronic device; “forward” direction, as explained previously, is the direction in which the user faces while wearing a device. For example, in some examples where second electric device 410 are earphones, the second orientation vector 508 is an orthogonal vector emanating from the center of the distance between the earphones. In other examples, when second electronic device 410 is headphones or earphones, like shown in FIG. 4A, then second orientation vector 508 may originate from the center of the head of user 501. In some examples, the second orientation vector 508 is sent to first electronic device 101 from the second electronic device 410. In other examples, first electronic device 101 tracks the second orientation vector 508 of second electronic device 410. Furthermore, the second orientation vector 508 will shift relative to the position of user 501 in the three-dimensional environment 500 as user 501 moves their head or moves around three-dimensional environment 500. In some examples, when second electronic device 410 plays the spatial audio, the second orientation vector 508 is used to track the movements of user 501 and output the spatial audio in the same one or more second locations 502, 504, and 506, regardless of user movement. In some examples, second orientation vector 508 is tracked constantly. In other examples, second orientation vector 508 may be tracked periodically, at intervals, when triggered an event, when one or more criteria are satisfied, or anything similar.

In some examples, first orientation vector 310 and second orientation vector 508 are used and compared to one another when transfer of the spatial audio is indicated. Whichever “forward” direction (e.g., orientation vector) first electronic device 101 is using to spatialize the audio is compared to the “forward” direction of second electronic device 410, and then the spatial audio is transferred to be played at the same locations (e.g., one or more second locations 502, 504, and 506) but using the second orientation vector 508.

In some examples, the one or more first locations 302, 304, and 306 and the one or more second locations 502, 504, and 506 may be the same. This is due to first orientation vector 310 of first electronic device 101 and second orientation vector 508 of second electronic device 410 being the same, or similar (e.g., within a threshold). For example, as shown in FIG. 5A, first orientation vector 310 of the head-mounted device and second orientation vector 508 of the earphones are both the same because both devices are worn on the head of user 501 and do not move substantially relative to the head of the user 501 while in use. When there is no difference in the orientations of the devices, and an indication to transfer audio is received, then transferring the spatial audio includes transferring the audio without using second orientation vector 508 to spatially change the one or more first locations 302, 304, and 306. However, in some examples, once the head-mounted device (e.g., first electronic device 101) is removed, like in FIG. 5B, then second orientation vector 508 is used to spatialize the audio and the one or more first locations 302, 304, and 306 and one or more second locations 502, 504, and 506 stay in the same spatial locations; this is because second orientation vector 508 is substantially the same as the first orientation vector 310 before the head-mounted device was removed.

In some examples, once the transfer indication is received at first electronic device 101, an offset between first orientation vector 310 and second orientation vector 508 is calculated at first electronic device 101. As used herein, this offset between the vectors is a numerical value measuring the difference in direction and location of first orientation vector 310 compared to the second orientation vector 508. In some examples, the offset may be more than a single measurement or value. In some non-limiting examples, this offset may include an angle measurement, a distance, a time stamp, etc. For example, as shown in FIG. 5A, offset 510 between the first orientation vector 310 and second orientation vector 508 is shown in angle O. Although the frames of reference look similar, there may still be a small offset 510 between the vectors that meets a threshold and would cause the transfer of spatial audio to use the offset calculation between the first orientation vector 310 and second orientation vector 508. In some examples, to determine this offset 510, first electronic device 101 and second electronic device 410 will need to capture tightly time-synced poses of their own orientation vectors at the moment the indication for transfer is received. First electronic device 101, in some examples, may then calculate and measure the rotation or change in position from the old “front” (e.g., first orientation vector 310) to the new “front” (e.g., second orientation vector 508) in relation to the position of user 501 in the three-dimensional environment 500. In some examples, a distance between first electronic device 101 and second electronic device 410 may be calculated as a part of the offset 510 to help transfer the spatial audio. In some examples, the offset 510 between first orientation vector 310 and second orientation vector 508 is calculated when first electronic device 101 initiates the playback of the spatial audio or when an application that plays spatial audio is launched. In some other examples, the calculation of the offset 510 occurs once second electronic device 410 is paired to first electronic device 101, such as via Bluetooth and/or another connection. In other examples, the calculation occurs once the earphones (e.g., second electronic device 410) are sensed to be in the ears of user 501. Further, in other examples, the calculation occurs when the spatial audio is playing, or when an application on first electronic device 101 is playing spatial audio. In some examples, the offset 510 is calculated before, during, or after the indication to transfer playback of the spatial audio is received. Once the offset 510 is calculated, the first electronic device 101 will use the offset 510 to help transfer and generate the spatial audio from the perspective of the second orientation vector 508 at the second electronic device 410. In some examples, multiple calculations of the offset can occur. For example, the offset calculation can be updated at different stages of the process, such as, for example, when a device is paired, when an application is launched, when playback of the spatial audio is performed, and/or when the indication is received.

In some examples, first electronic device 101 generates the spatial audio using second orientation vector 508 and the offset 510 between first orientation vector 310 and the second orientation vector 508. First electronic device 101 uses the translation of information from the offset 510 calculation to then transfer the spatial audio to play at one or more second locations 502, 504, and 506 using the second orientation vector 508 of second electronic device 410. First electronic device 101 may seamlessly transfer audio between devices so that no static, pauses, interruptions, or anything similar occur when transferring the spatial audio. In some examples, the first electronic device 101 uses the offset 510 to calculate how much the spatial audio locations need to be shifted to output the spatial audio at the one or more second locations 502, 504, and 506. Spatial audio is preserved between devices, or restarted using the new directional information (e.g., second orientation vector 508). Further, in some examples, first orientation vector 310 and the second orientation vector 508 may have corresponding frames of reference associated with the same origin point to help make the spatial audio transfer more seamless. For example, when a 45-degree angle offset between the first orientation vector 310 and the second orientation vector 508 with the same origin is detected (e.g., no motion), then first electronic device 101 shifts the one or more first locations 302, 304, and 306 by 45 degrees in the same direction as the offset 510, thus landing at the new locations being one or more second locations 502, 504, and 506.

In some examples, the spatial audio generation using second orientation vector 508 and the offset between first orientation vector 310 and second orientation vector 508 may be achievable when one or more criteria are satisfied. The one or more criteria optionally include specific circumstances that must exist in order for first electronic device 101 to generate the spatial audio using second orientation vector 508 and the offset between first orientation vector 310 and second orientation vector 508. In some examples, the one or more criteria may include a battery level threshold, an indication whether the first electronic device 101 is worn on the head of user 501, an indication that both the first electronic device 101 and second electronic device 410 are worn on the head of user 501, an indication that second electronic device 410 is a head worn device, the offset between first orientation vector 310 and second orientation vector 508 meeting or exceeding an angular threshold distance, a distance between an initial location of first electronic device 101 and a second location of first electronic device 101 meeting a threshold distance. However, in some examples, when the one or more criteria are not satisfied, then the first electronic device 101 generates the spatial audio using first orientation vector 310 without using second orientation vector 508.

For example, the one or more criteria include a battery level of first electronic device 101 not meeting a specific battery level threshold value. When the battery level of first electronic device 101 is below this value, then the one or more criteria is satisfied, and the spatial audio is generated using second orientation vector 508 and the offset between first orientation vector 310 and second orientation vector 508. When the battery level of first electronic device 101 meets or exceeds the battery level threshold value, then the one or more criteria is not met. Then, first electronic device 101 may generate the spatial audio using first orientation vector 310.

Furthermore, as another example, the one or more criteria include an indication that both the first electronic device 101 and second electronic device 410 are worn on the head of user 501. When an indication is received that both first electronic device 101 and second electronic device 410 are worn on the head of user 501, then the one or more criteria are not satisfied and the first electronic device 101 generates the spatial audio using the first orientation vector 310 without using the second orientation vector 508; when both devices are worn on the head of user 501, then they have the same or similar orientation vectors (e.g., within a threshold), and no offset or a small offset (e.g., within a threshold)may be detected. When an indication is received that both first electronic device 101 and second electronic device 410 are not worn on the head of user 501, then the one or more criteria are met. Then, first electronic device 101 may generate the spatial audio using second orientation vector 508 and the offset 510 between first orientation vector 310 and second orientation vector 508.

In some examples, the locations of one or more first locations 302, 304, and 306 and the one or more second locations 502, 504, and 506 are dependent on the size of the offset 510 between first orientation vector 310 and second orientation vector 508. For example, when the one or more criteria are met and the spatial audio is generated using the offset between first orientation vector 310 and second orientation vector 508, then the one or more second locations 502, 504, and 506 may be in slightly different locations than the one or more first locations 302, 304, and 306. Furthermore, in some examples, when the one or more criteria are not met and the spatial audio generated using first orientation vector 310 without using second orientation vector 508, then one or more first locations 302, 304, and 306 and the one or more second locations 502, 504, and 506 may be the same or similar (e.g., within a threshold distance).

In some examples, FIGS. 5A and 5B illustrate two possible scenarios where the one or more criteria are not met. In FIG. 5A, user 501 wears both first electronic device 101 and second electronic device 410 on their head. This situation does not satisfy the one or more criteria, as explained above, since first orientation vector 310 and second orientation vector 508 have a small (e.g., within a threshold), or nonexistent, offset 510 between them when both are worn on the head of user 501, for example. First electronic device 101 then outputs the spatial audio using the first orientation vector 310 because the first orientation vector is the same or similar enough to second orientation vector 508 that the spatial audio generation does not change, and one or more second locations 502, 504, and 506 are the same as one or more first locations 302, 304, and 306. In FIG. 5A, the spatial audio is being output by the one or more first audio output devices 308 and the one or more second audio output devices 412 simultaneously, wherein first electronic device 101 does the spatializing of the audio and second electronic device 410 acts as an audio output device. In FIG. 5B, user 501 wears second electronic device 410 and spatialization of the spatial audio has been fully transferred from first electronic device 101 to second electronic device 410. This situation does not satisfy the one or more criteria, since, similar to above, first orientation vector 310 and second orientation vector 508 have a small (e.g., within a threshold), or nonexistent, offset 510 between them (e.g., both are extruding forward from the user's head, which has not moved or rotated). First electronic device 101 then outputs the spatial audio using the first orientation vector 310 because first orientation vector is the same or similar enough to second orientation vector 508 that the spatial audio generation does not change, and one or more second locations 502, 504, and 506 are the same as one or more first locations 302, 304, and 306. Further, in some examples, like FIG. 5B, the same outcome, or spatial audio generation, occurs when the first electronic device 101 used second orientation vector 508 and the offset 510 between first orientation vector 310 and second orientation vector 508. This is because there was no offset 510 between vectors and the first orientation vector 310 is the same as second orientation vector 508.

In some examples, and in response to receiving the indication to transfer the spatial audio to the one or more second audio output devices 412, first electronic device 101 then transmits the spatial audio to the second electronic device 410, using one of the generation methods described above depending on whether the one or more criteria were met. First electronic device 101 transmits the spatial audio and simultaneously initiates playback of the spatial audio using the one or more second audio output devices 412 at one or more second locations 502, 504, and 506 within the three-dimensional environment 500 corresponding to the one or more first locations 302, 304, and 306 within the three-dimensional environment 300.

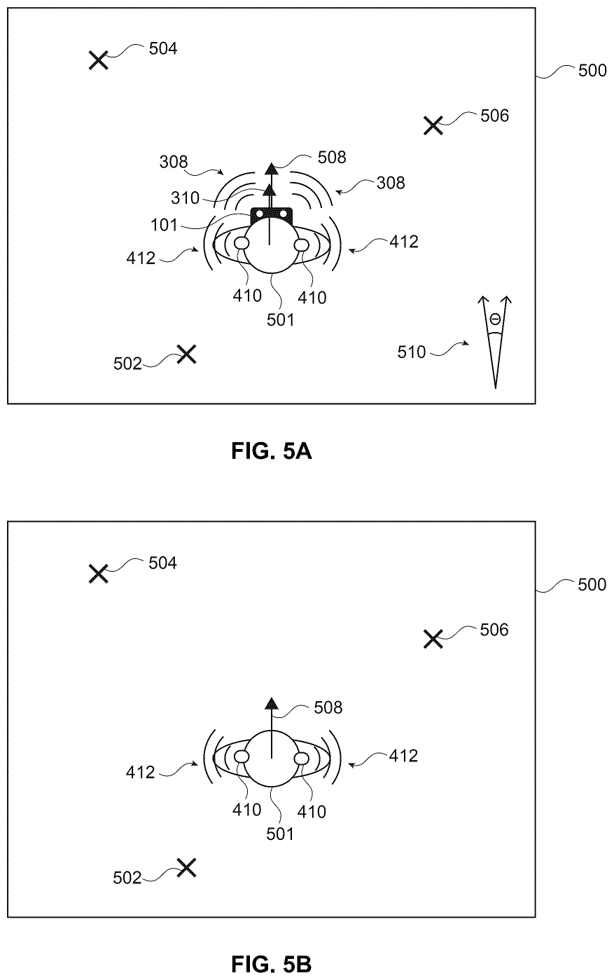

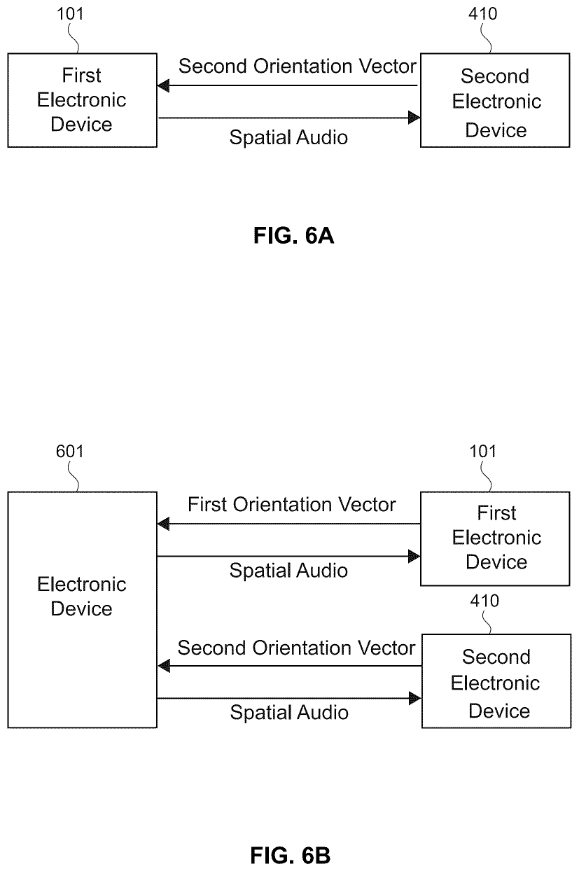

Referring now to FIG. 6A, shown is a block diagram illustrating the communication between first electronic device 101 and second electronic device 410. In some examples, second electronic device 410 transfers its second orientation vector 508 to first electronic device 101. This transfer of communication may happen prior to, during, or after the indication to transfer the spatial audio is received at first electronic device 101. Now that first electronic device 101 is tracking its own first orientation vector 310 and receiving the second orientation vector 508 from the second electronic device 410 tracking the second orientation vector 508, the first electronic device 101 can compare the different frames of reference and calculate the offset 510 between to the two. Once this offset 510 is calculated, first electronic device 101 then transfers the spatial audio to second electronic device 410 to perform playback of the spatial audio at the second electronic device 410 or both first electronic device 101 and second electronic device 410. In some examples, second electronic device 410 is an audio output device and is incapable of spatializing the spatial audio on its own. In some examples, first electronic device 101 has more accurate calculation and tracking capabilities than second electronic device 410.

For example, a user can request to switch playback of spatial audio from a head-mounted device (e.g., first electronic device 101) to earphones (e.g., second electronic device 410). The head-mounted device can receive the earphone's frame of reference (e.g., second orientation vector 508) once the indication to transfer spatial audio is received or can continuously send its tracking (e.g., its orientation vector) to the head-mounted device. The head-mounted device then calculates the offset, or difference, between the two orientation vectors and applies the difference to the frame of reference of the earphones. When the head-mounted device sends the spatial audio to the earphones, the head-mounted device also sends this new, adjusted frame of reference to tell the earphone where to output the spatial audio. In some examples, tracking capabilities of the second orientation vector 508 may be transferred fully to the earphones once the user removes the head-mounted device or indicates the head-mounted device is no longer in use. In some examples, indication to transfer the spatial audio to the one or more second audio output devices includes detecting a doff of the first electronic device. Doff, as used herein, is the opposite of don; whereas don corresponds to initiating wearing of a wearable device (e.g., inserting earbuds in ears, affixing an HMD or headphones to the head), doff corresponds to removing the wearable device (e.g., removing earbuds from the ears, removing the HMD or headphones from the head). In this case, the earphones may not know the last, true position of the head-mounted device's orientation, so this information can be transferred from the HMD to the earphones for use as a baseline or starting frame of reference. However, the head-mounted device must still remain powered on to perform the spatialization of the audio, since the earphones cannot perform that capability.

Moreover, in some examples, sensor fusion may occur between first electronic device 101 and second electronic device 410. While performing other processes, first electronic device 101 can track first orientation vector 310 and can receive tracking of second orientation vector 508 from second electronic device 410, so once the indication to transfer the audio is received, the calculation of the offset 510 and transfer of the audio can be seamless. In some examples, both first electronic device 101 and second electronic device 410 are algorithmically the same, meaning both devices have the capability to perform the same calculations and algorithms. The main difference between these devices, in some examples, is that first electronic device 101 may be more accurate in performing actions and calculations in addition to spatializing the spatial audio, which may lead to the first electronic device offloading the audio spatialization to the second electronic device 410 to save battery life, to improve memory usage on the first electronic device, or to perform other important duties.

In some examples, the first electronic device 101 performs the tracking and spatialization of the spatial audio without second electronic device 410 performing a portion of the tracking and spatialization of the spatial audio. In some cases, the tracking capability may be transferred to the second electronic device 410. However, in some other examples, tracking and spatialization capabilities may be performed on a separate, third electronic device in the ecosystem. This third device may be any sort of companion device or electronic device corresponding to electronic device 260 from FIG. 2A, including a companion device such as a mobile device, smartphone, hand-held computing device, or anything similar. This third electronic, companion device is referred to herein throughout as “electronic device 601”. In some examples, both first electronic device 101 and electronic device 601 perform the vector tracking and spatialization of the spatial audio together.

Now referring to FIG. 6B, an example block diagram illustrates the communication between an example electronic device 601, first electronic device 101, and second electronic device 410. The process described above for a handoff and synchronization of spatial audio between multiple devices will perform the same steps, however, now the steps will be performed on electronic device 601 rather than first electronic device 101. In some examples, first electronic device 101 now acts as an audio output device, similar to second electronic device 410. Electronic device 601 receives the first orientation vector 310 from first electronic device 101 and electronic device 601 spatializes the spatial audio and transfers the spatial audio to first electronic device 101. Similarly, electronic device 601 receives the second orientation vector 508 from second electronic device 410 and electronic device 601 spatializes the spatial audio and transfers the spatial audio to second electronic device 410, like first electronic device 101 does in the previously explained example process. Electronic device 601 receives both vectors from their respective devices and calculates the offset between the two. For example, a mobile device receives the frame of references from a head-mounted device and a pair of earphones. The mobile device has the ability to detect the differences between the frame of reference of the head-mounted device and the frame of reference of the earphones and can transfer playback of the spatial audio between the devices and their respective spatial audio locations seamlessly. In some examples, electronic device 601 may have its own one or more audio output devices to initiate playback of the spatial audio.

In some examples, depending on the battery level of electronic device 601, the spatialization of the spatial audio and the vector tracking capabilities can be handed off to first electronic device 101. For example, when the battery level of a mobile phone spatializing spatial audio for the ecosystem of devices is below 20%, electronic device 601 will handoff the spatialization and/or tracking capabilities to first electronic device 101.

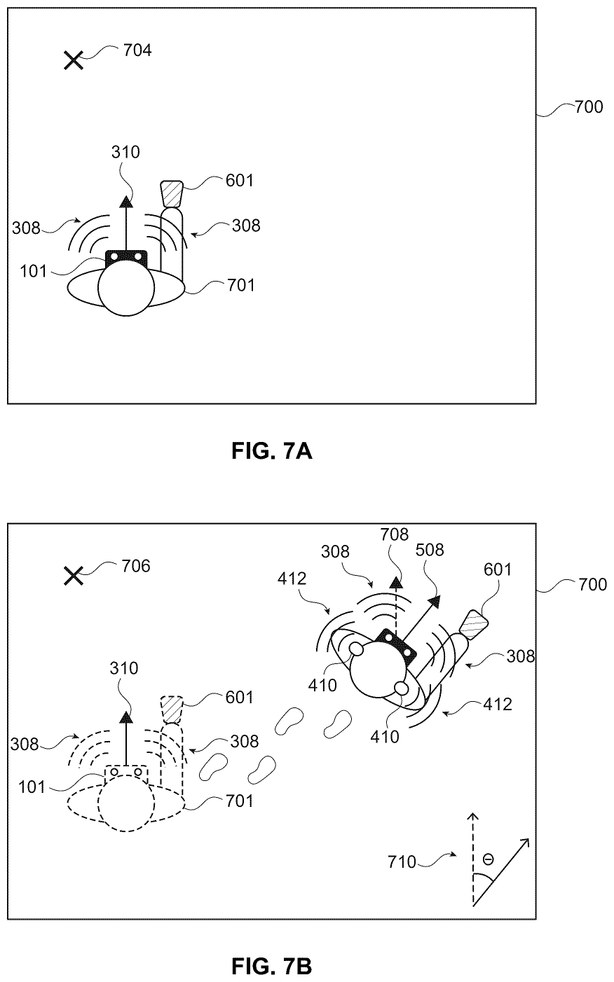

Some examples of the disclosure are directed to a method at an electronic device (e.g., companion device). The electronic device may be any companion device described herein such as a mobile device. FIGS. 7A and 7B are directed to a method for handoff and synchronization of spatial audio between multiple devices being processed at a companion device (e.g., electronic device 601) rather than first electronic device described herein. Shown is a user 701 in a three-dimensional environment 700 performing and initiating playback of spatial audio using an electronic device 601, first electronic device 101, and second electronic device 410.

As previously disclosed, electronic device 601 communicates with a first electronic device 101 including one or more first audio output devices 308 and a second electronic device 410 including one or more second audio output devices 412. As shown in FIG. 7A, a user 701 holds electronic device 601 and wears first electronic device 101. In some examples, electronic device 601 receives a first indication to initiate playback of spatial audio using the one or more first audio output devices 308. A first indication may be any indication previously disclosed herein, but this one must be associated with performing playback of the spatial audio at first electronic device 101. For example, first indication may include connecting the head-mounted device to the mobile device. Thus, as mentioned above in FIG. 6B, first electronic device 101 sends its first orientation vector 310 to electronic device 601, which, in response to the first indication, then generates the spatial audio using first orientation vector 310 of the first electronic device 101 obtained from first electronic device 101.

In some examples, in response to the first indication and after generating the spatial audio, electronic device 601 transmits the spatial audio to first electronic device 101 for playback of the spatial audio using the one or more first audio output devices 308 at one or more first locations 704 within the three-dimensional environment 700, as FIG. 7A shows. Though electronic device 601 is shown, the spatial audio is being outputted at the one or more first audio output devices 308 of first electronic device 101 in FIG. 7A.

Furthermore, in some examples, electronic device 601 then receives a second indication to initiate playback of spatial audio using the one or more second audio output devices 412 of second electronic device 410. Second indication may be any indication disclosed herein. For example, the second indication may include an indication of connecting the earphones to the mobile device. Also, the second indication could include an indication of pairing the earphones to both the head-mounted device and the mobile device. From this step forward, the process is similar or the same as the previously disclosed process, however now the companion device (e.g., electronic device 601) performs the process rather than first electronic device 101.

In FIG. 7B, shown is user 701 listening to spatial audio on a head-mounted device, but has now moved within the three-dimensional environment 700 and has indicated, through the second indication, to transfer playback of the spatial audio to the earphones from the head-mounted device. Movement is an important criterion to consider when transferring spatial audio between devices because movement affects each device's frame of reference. The figure shows user 701 has now moved to different location within the three-dimensional environment 700. In some examples, in response to the second indication and in accordance with a determination that one or more criteria are satisfied, electronic device 601 generates the spatial audio using a second orientation vector 708 of the first electronic device 101 obtained from the first electronic device 101 and an offset between first orientation vector 310 of the first electronic device 101 and the second orientation vector 508 received from the second electronic device 410. The second orientation vector 708 received from first electronic device 101 is different from first orientation vector 310 because this vector was sent after the user moved (e.g., when the second indication is received), and first orientation vector 310 was tracked based on the user's position when the first indication was received. Moreover, one or more criteria may be any criteria disclosed herein and applicable to the current process. For example, one or more criteria may include a criterion that is satisfied when both the first electronic device 101 and the second electronic device 410 are connected to electronic device 601. Additionally, one or more criteria may include a user input received at the mobile device to initiate playback of the spatial audio using the one or more second audio output devices of second electronic device 410. Electronic device 601 performs the calculation of the offset between vectors (shown as offset 720 in FIG. 7B) by comparing the first orientation vector 310 to second orientation vector 508. This offset is then further compared to the second orientation vector 708 of first electronic device 101 to see how the movement of user 701 affects the spatialization of the spatial audio when switching between the two devices. In some examples, electronic device 601 then transmits the spatial audio to the second electronic device 410 for playback of the spatial audio using the one or more second audio output devices at one or more second locations 706 within the three-dimensional environment corresponding to the one or more first locations 704 within the three-dimensional environment.

For example, electronic device 601 was generating the spatial audio based on the head-mounted device's frame of reference and then once the second indication is received and the spatial audio is transferred to the one or more second audio output devices 412, is now generating the spatial audio based on the earphone's frame of reference. In some examples, the earphones may be tracking their own frame of reference or the head-mounted device may be tracking the earphone's frame of reference and sending that information over to the mobile device, including the head-mounted device's own frame of reference. Furthermore, in some examples, user 701 does not only move within the three-dimensional environment 700, but also rotates their head. These head movements can be detected at the head-mounted device or mobile device and the spatial audio will be adjusted based on those movements. To help with this, in some examples, the mobile device and head-mounted device may have the locations of all audio outputs in the ecosystem stored in their respective memories. In some other examples, both devices may have one or more cameras to detect the locations.

Additionally, in some examples, both the electronic device 601 and first electronic device 101 are capable of tracking the movement of user 701 through the three-dimensional environment 700 and can send this information to other devices in the ecosystem when necessary. However, in some examples, second electronic device 410 is incapable of tracking the user's motion. Thus, the change in position of user 701 is determined through the first orientation vector 310 and the new, second orientation vector 708 of first electronic device 101 and used to help calculate the offset and output the spatial audio at one or more second locations 706.

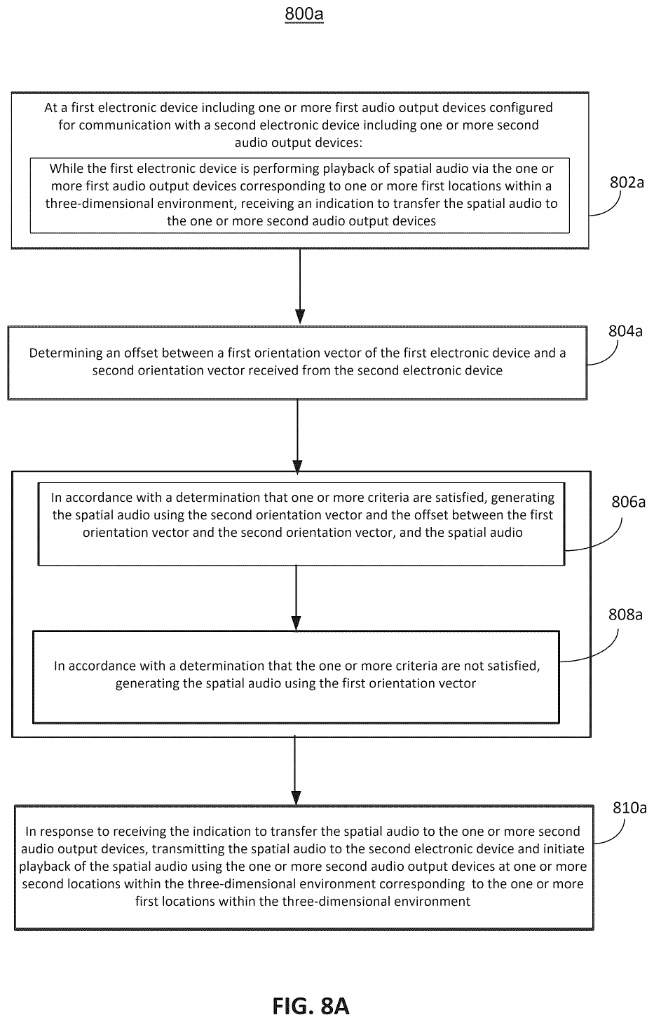

FIG. 8A illustrates a flow diagram illustrating an example process for handoff and synchronization of spatial audio between multiple devices according to some examples of the disclosure. In some examples, process 800a begins at a first electronic device 101 including one or more first audio output devices 308 configured for communication with a second electronic device 410 including one or more second audio output devices 412. In some examples, as shown in FIGS. 4A-4C, the first electronic device 101 may be a head-mounted display with integrated speakers and the second electronic device 410 may be earphones with integrated speakers. In some examples, the first electronic device 101 includes one or more cameras that enable audio spatialization based on locations of physical objects in the three-dimensional environment. Further, and in some examples, first electronic device 101 includes one or more accelerometers to help differentiate between locomotion and head movement of a user. In some examples, at 802a, while the first electronic device 101 is performing playback of spatial audio via the one or more first audio output devices 308 corresponding to one or more first locations 302, 304, and 306 within a three-dimensional environment, the electronic device receives an indication to transfer the spatial audio to the one or more second audio output devices 412, which is illustrated through FIGS. 4B and 5A. The indication may include connecting second electronic device 410 to first electronic device 101 via Bluetooth. In some examples, indication to transfer the spatial audio to the one or more second audio output devices 412 includes detecting a doff of the first electronic device 101. In some examples, the spatial audio is generated based on a mapping of the three-dimensional environment obtained from memory of the first electronic device 101.

In some examples, at 804a, the first electronic device 101 determines an offset between a first orientation vector 310 of the first electronic device 101 and a second orientation vector 508 received from the second electronic device 410. In some examples, the offset between the first orientation vector 310 and the second orientation vector 508 is determined when first electronic device 101 initiates the playback of the spatial audio or when an application that plays spatial audio is launched. In other examples, the offset between the first orientation vector 310 and the second orientation vector 508 is determined when the second electronic device 410 is paired to the first electronic device 101. In some examples, the offset between the first orientation vector 310 and the second orientation vector 508 is determined before the indication is received. In other examples, the offset between the first orientation vector 310 and the second orientation vector 508 is determined when the indication is received.

In some examples, at 806a, in accordance with a determination that one or more criteria are satisfied, first electronic device 101 generates the spatial audio using the second orientation vector 508 and the offset between the first orientation vector 310 and the second orientation vector 508, and the spatial audio. In some examples, at 808a, in accordance with a determination that the one or more criteria are not satisfied, first electronic device 101 generates the spatial audio using the first orientation vector 310. For example, one or more criteria include a criterion satisfied when the first electronic device 101 is detected as worn by a user, as shown in FIGS. 4A-C. In another example, one or more criteria include a criterion that is satisfied when the second electronic device 410 is detected as worn by the user. In some examples, the one or more criteria include a criterion that is satisfied when a battery level of the first electronic device 101 is below a battery level threshold. In some examples, at 810a, in response to receiving the indication to transfer the spatial audio to the one or more second audio output devices 412, first electronic device 101 transmits the spatial audio to the second electronic device 410 and initiates playback of the spatial audio using the one or more second audio output devices 412 at one or more second locations 502, 504, and 506 within the three-dimensional environment corresponding to the one or more first locations 302, 304, and 306 within the three-dimensional environment. In some examples, the one or more first locations 302, 304, and 306 within the three-dimensional environment and one or more second locations 502, 504, and 506 within the three-dimensional environment are the same locations when generating the spatial audio using the first orientation vector 310. In some examples, the first electronic device 101 continues performing the playback of the spatial audio via the one or more first audio output devices 308 concurrently with the playback of the spatial audio using the one or more second audio output devices 412.

FIG. 8B illustrates a flow diagram illustrating an example process for handoff and synchronization of spatial audio between multiple devices according to some examples of the disclosure, with the addition of a battery level criterion. In some examples, process 800b begins at a first electronic device 101 including one or more first audio output devices 308 configured for communication with a second electronic device 410 including one or more second audio output devices 412. In some examples, as shown in FIGS. 4A-4C, the first electronic device 101 may be a head-mounted display with integrated speakers and the second electronic device 410 may be earphones with integrated speakers. In some examples, at 802b, while the first electronic device 101 performs playback of spatial audio via the one or more first audio output devices 308 corresponding to one or more first locations 302, 304, and 306 within a three-dimensional environment, the electronic device receives an indication to transfer the spatial audio to the one or more second audio output devices 412, which is illustrated through FIGS. 4B and 5A. In some examples, at 804b, the first electronic device 101 determines an offset between a first orientation vector 310 of the first electronic device 101 and a second orientation vector 508 received from the second electronic device 410. In some examples, at 806b, in accordance with a determination that a battery level of the first electronic device 101 is less than a threshold battery level, first electronic device 101 generates the spatial audio using the second orientation vector 508 and the offset between the first orientation vector 310 and the second orientation vector 508, and the spatial audio. In some examples, in 808b, in accordance with a determination that the battery level of the first electronic device 101 meets and/or exceeds a threshold battery level, first electronic device 101 generates the spatial audio using the first orientation vector 310. In some examples, at 810b, in response to receiving the indication to transfer the spatial audio to the one or more second audio output devices 412, first electronic device 101 transmits the spatial audio to the second electronic device 410 and initiates playback of the spatial audio using the one or more second audio output devices 412 at one or more second locations 502, 504, and 506 within the three-dimensional environment corresponding to the one or more first locations 302, 304, and 306 within the three-dimensional environment.

FIG. 8C illustrates a flow diagram illustrating an example process for handoff and synchronization of spatial audio between multiple devices according to some examples of the disclosure, with the addition of a criterion that is satisfied when the user is detected to be wearing both the first electronic device 101 and the second electronic device 410. In some examples, process 800c begins at a first electronic device 101 including one or more first audio output devices 308 configured to communicate with a second electronic device 410 including one or more second audio output devices 412. In some examples, as shown in FIGS. 4A-4C, the first electronic device 101 may be a head-mounted display with integrated speakers and the second electronic device 410 may be earphones with integrated speakers. In some examples, at 802c, while the first electronic device 101 is performing playback of spatial audio via the one or more first audio output devices 308 corresponding to one or more first locations 302, 304, and 306 within a three-dimensional environment, receiving an indication to transfer the spatial audio to the one or more second audio output devices 412, which is illustrated through FIGS. 4B and 5A. In some examples, at 804c, the first electronic device 101 determines an offset between a first orientation vector 310 of the first electronic device 101 and a second orientation vector 508 received from the second electronic device 410. In some examples, at 806c, in accordance with a determination that both the first electronic device 101 and the second electronic device 410 are not worn by a user simultaneously, first electronic device 101 generates the spatial audio using the second orientation vector 508 and the offset between the first orientation vector 310 and the second orientation vector 508, and the spatial audio. In some examples, at 808c, in accordance with a determination that both the first electronic device 101 and the second electronic device 410 are worn by a user simultaneously, first electronic device 101 generates the spatial audio using the first orientation vector 310. In some examples, at 810c, in response to receiving the indication to transfer the spatial audio to the one or more second audio output devices 412, first electronic device 101 transmits the spatial audio to the second electronic device 410 and initiates playback of the spatial audio using the one or more second audio output devices 412 at one or more second locations 502, 504, and 506 within the three-dimensional environment corresponding to the one or more first locations 302, 304, and 306 within the three-dimensional environment.

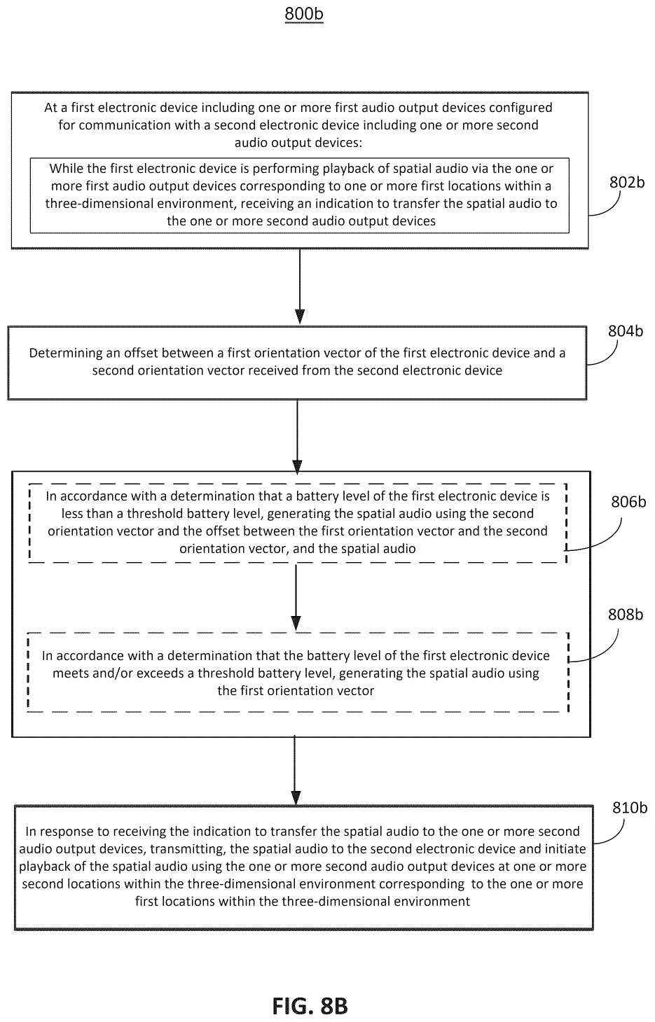

FIG. 9 illustrates a flow diagram illustrating an example process for handoff and synchronization of spatial audio between multiple devices according to some examples of the disclosure, with the inclusion of a companion device, referred to herein as “electronic device 601”. In some examples, process 900 begins at an electronic device 601 configured for communication with a first electronic device 101 including one or more first audio output devices 308 and a second electronic device 410 including one or more second audio output devices 412. In some examples, electronic device 601 is a mobile device, first electronic device 101 is a head-mounted device, and second electronic device 410 are earphones. In some examples, at 904, electronic device 601 receives a first indication to initiate playback of spatial audio using the one or more first audio output devices 308. In some examples, at 906, electronic device 601 transmits the spatial audio to the first electronic device 101 for playback of the spatial audio using the one or more first audio output devices 308 at one or more first locations 704 within the three-dimensional environment. In some examples, at 908, electronic device 601 receives a second indication to initiate playback of spatial audio using the one or more second audio output devices 412. In some examples, at 910 and in response to the second indication, in accordance with a determination that one or more criteria are satisfied, electronic device 601 generates the spatial audio using a second orientation vector 708 of the first electronic device 101 obtained from the first electronic device 101 and an offset between the first orientation vector 310 of the first electronic device 101 and the second orientation vector 508 received from the second electronic device 410. In some examples, the offset between the first orientation vector 310 of the first electronic device 101 and the second orientation vector 508 received from the second electronic device 410 is determined when the first electronic device 101 and the second electronic device 410 are paired to the electronic device 601. In some examples, the second orientation vector 708 of the first electronic device 101 is tracked after electronic device 601 receives the second indication. In other examples, the offset between the first orientation vector 310 of the first electronic device 101 and the second orientation vector 508 received from the second electronic device 410 is determined after the second indication is received. In some examples, at 912 and in response to the second indication, in accordance with a determination that one or more criteria are satisfied, electronic device 601 transmits the spatial audio to the second electronic device 410 for playback of the spatial audio using the one or more second audio output devices 412 at one or more second locations 706 within the three-dimensional environment corresponding to the one or more first locations 704 within the three-dimensional environment. In some examples, one or more criteria include a criterion that is satisfied when a battery level of the electronic device 601 is below a battery level threshold.

Attention is now directed towards systems and methods for synchronization of visual content with spatial audio between devices based on a visual content location and the orientation of the devices. This includes transmitting the spatial audio to headphones or earphones to simulate the spatial audio emanating from the same location as the visual content. The system 1000 includes a mobile device 601 corresponding to electronic device 601 explained previously (e.g., a mobile device, such as a smartphone, tablet, computer, or wearable device) as described previously herein, a head-mounted device 1001 (e.g., a head-mounted device or HMD) corresponding to first electronic device 101 explained previously herein, and an audio output device 410 (e.g., an audio output device such as earbuds, headphones, and/or one or more speakers) corresponding to second electronic device 410 as previously described herein.

Some electronic devices are capable of outputting spatialized audio signals, in which audio content is processed to make the audio content sound to a user as though audio sources of the audio content are emanating from a simulated source location in the environment around the user. In some cases, the system 1000 presents audio content to simulate multiple audio sources at different locations in the environment. Additionally or alternatively, in some examples, the simulated source(s) can move or change locations in the three-dimensional environment. In some cases, the spatial audio is associated with virtual media content (e.g., videos, music, podcasts, social media, etc.) being displayed to a user via a head-mounted device 1001 and both the virtual media content and spatial audio possess the same simulated source location. As the user moves in the environment, the simulated source location sounds to the user as remaining fixed in the environment, thus fixed at the location where the visual content is being displayed to the user. A mobile device generating the spatial audio can use a frame of reference of the head-mounted device 1001, such as a reference orientation tracked by one or more sensors of the head-mounted device 1001 or the mobile device 610, to present the spatial audio to simulate the audio emanating from the same source location as the virtual media content. As described herein, in some examples, the mobile device displays virtual media content to a user through a head-mounted device 1001 and transmits playback of spatial audio associated with the visual content at a pair of headphones or earphones to simulate the spatial audio playing from the simulated source location of the virtual media content.

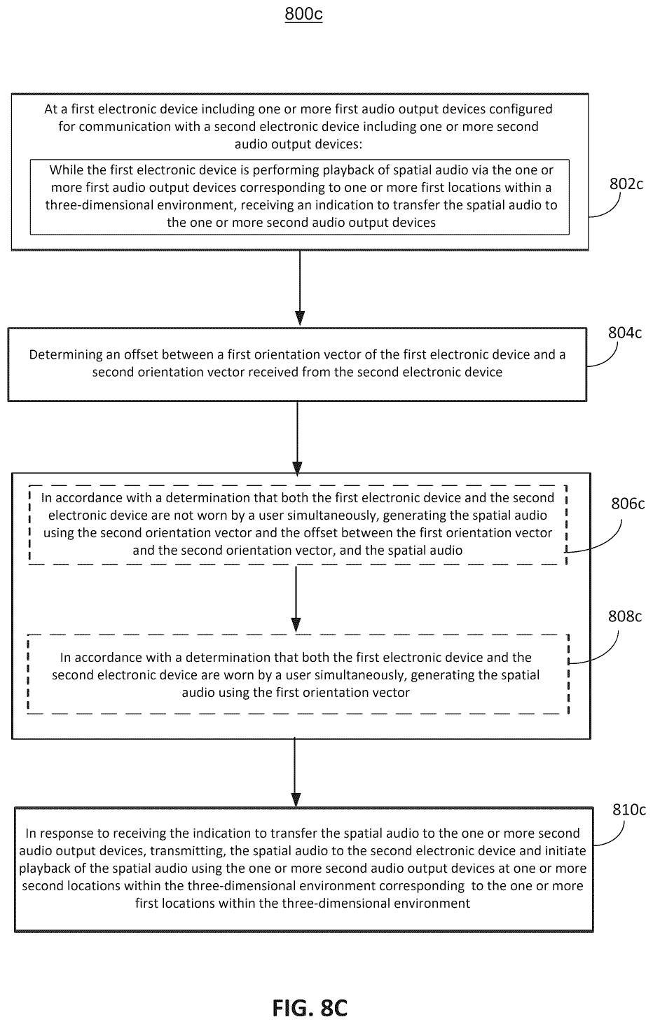

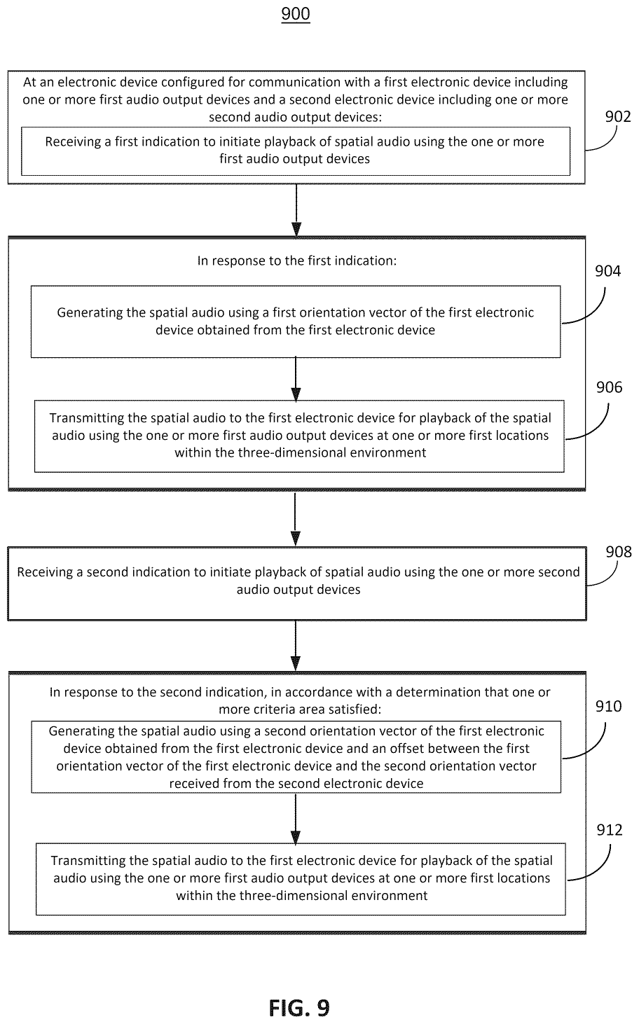

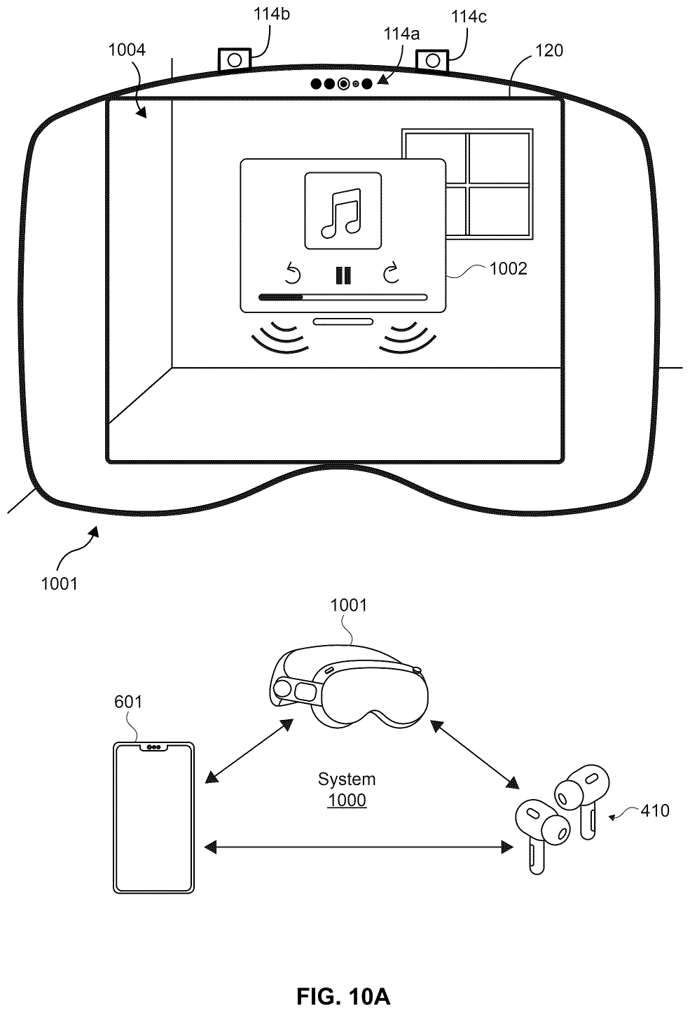

FIG. 10A illustrates an example of a head-mounted device 1001 displaying visual content 1002 to a user and a glyph of an exemplary system 1000. In some examples, the method described herein is performed on a mobile device 601 as explained previously as electronic device 601 or electronic device 201. In some examples, the mobile device 601 is in communication with multiple devices in a system 1000, such as the head-mounted device 1001 corresponding to first electronic device 101 and audio output device 410 corresponding to second electronic device 410 in the system 1000 herein. In some examples, the mobile device 601 is configured to perform all of the computation and spatialization of the spatial audio and visual content 1002 to be sent to the head-mounted device 1001 and audio output device 410 in the system 1000. In some examples, descriptions herein of operations performed by the system 1000 are optionally performed by any one (or more) electronic devices (e.g., mobile device 601, head-mounted device 1001, and audio output device 410) included in the system 1000.

Exemplary system 1000 includes a mobile device 610, (e.g., electronic device 601) head-mounted device 1001 (first electronic device 101), and an audio output device 410 (e.g., second electronic device 410) all in communication with one another. In some examples, the mobile device 601) is configured to be in communication with a head-mounted device 1001. In some examples, the head-mounted device 1001 is any electronic display device described herein configured to present a user with a three-dimensional environment via a display while the device (or display) is worn on a head of the user. In some examples, the mobile device 601 generates and transmits visual content to the head-mounted device 1001 for display. In some cases, the mobile device 601 controls the display 120 of head-mounted device 1001. In other examples, the head-mounted device 1001 controls its own display 120. As shown in FIG. 10A, the head-mounted device 1001 is configured to display visual content 1002 in the virtual environment to a user via one or more displays 120. As described herein, visual content 1002 is any sort of media content that includes spatial audio, for example. In some examples, the visual content 1002 is any sort of media that has both visual and spatial audio content, for example. For example, the virtual media displayed in the virtual environment through the head-mounted device 1001 is a music application, a movie, a video, a virtual animation, television programming, or a picture with audio. In some examples, the mobile device 601 displays the visual content in a specific location in the three-dimensional environment via the display; this location where the visual content is displayed is called the visual content location.

FIG. 10B illustrates the system 1000 presenting a three-dimensional environment 1004. Relatedly, FIG. 10B shows the bird's eye view of the same environment displayed using the head-mounted device 1001 in FIG. 10A. In some examples, three-dimensional environment 1004 is any three-dimensional environment described herein and visual content 1002 possesses any characteristics of any virtual objects described herein. In some examples, visual content 1002 is displayed using the head-mounted device 1001 so that the user watches or views the visual content playing at a location in the three-dimensional environment 1004, shown as visual content location 1003. Visual content location 1003 is a location in three-dimensional environment 1004 where the system 1000 simulates virtual content 1002 being located. For example, the system 1000 displays the virtual content 1002 to appear to be located at the visual content location 1003 in the three-dimensional environment 1004. Visual content location 1003 is included in FIGS. 10B-10C for illustrative purposes; it should be understood that the system 1000 does not necessarily display visual content location 1003 as an element different from visual content 1002. In some examples, visual content location 1003 is determined at the mobile device 601 and sent to the head-mounted device 1001 for display or is generated at the head-mounted device 1001 itself. In some examples, as the user moves their head around or moves throughout a three-dimensional environment 1004, the visual content location stays in the same location relative to the three-dimensional environment 1004 and does not change or move with the user. In some examples, the mobile device 601 performs all the computing for tracking the three-dimensional environment 1004. In other examples, the head-mounted device 1001 or other devices in the system 1000 perform some or all of the tracking and computing.

In this embodiment and in some other examples, the mobile device 601 generates (e.g., using depth and/or image sensors on the mobile device 601 or head-mounted device 1001) or obtains (e.g., from memory) a representation of the three-dimensional environment 1004. The representation of three-dimensional environment 1004 is optionally a map of the environment and reflects the three-dimensional environment displayed on the head-mounted device 1001 to the user. In some examples, the representation includes representations of objects in the three-dimensional environment 1004 that optionally are accounted for in the generation of spatial audio. In some examples, the mobile device 601 or head-mounted device 1001 possess cameras to create and change the representation of three-dimensional environment 1004. Further, in some examples, the cameras are used to determine the position of the user and to help continuously track the visual content location 1003 in the three-dimensional environment 1004. In some examples, the placement of the visual content location (e.g., from which spatial audio emanates) is based on the representation of the three-dimensional environment 1004.

In some examples, the system 1000 tracks a first orientation vector 1005 of the head-mounted device 1001. An orientation vector, as previously explained here, is a vector from a position of the device and/or with an offset from the fixed position of the device. First orientation vector 1005 is associated with the head-mounted device 1001 described herein and is representative of the forward direction for a person wearing the head-mounted device 1001. In some examples, first orientation vector 1005 originates from the center of the head-mounted device 1001 and points forward. When the first electronic device is head-mounted device 1001, as shown in FIG. 10B, then the first orientation vector 1005 optionally originates from the center of the head of the user or the center of the head-mounted device 1001. In some examples, the magnitude of first orientation vector 1005 is not important, but the direction in which its points, representing what “forward” is to the head-mounted device 1001, is. In some examples, the mobile device 601 performs all the computing for tracking the first orientation vector 1005. In other examples, the head-mounted device 1001 and/or audio output device 410 perform some or all of the tracking and computing.

Furthermore, in some examples, the system 1000 generates the spatial audio related to visual content 1002. As used herein, “generates” refers to the ability to process the spatial audio for presentation using the relevant information received and/or tracked by the system 1000. While the mobile device 601 transmits the visual content, the mobile device 601 simultaneously generates the spatial audio related to the visual content 1002. To generate the spatial audio, the mobile device 601 uses the visual content location 1003 and the first orientation vector 1005 to determine the location in the three-dimensional environment from which to simulate the spatial audio emanating. In some examples, the mobile devices receive the visual content location 1003 and the first orientation vector 1005 from the head-mounted device 1001. In some other examples, the mobile device 601 tracks both the visual content location 1003 and the first orientation vector 1005. By using the frame of reference of the head-mounted device 1001 (e.g., the first orientation vector 1005) and the visual content location 1003, the mobile device 601 generates the spatial audio in a manner that simulates the audio coming from the same location at which the visual content appears to be located (e.g., the visual content location 1003). In some examples, the mobile device 601 performs all the computing for tracking the first orientation vector 1005. In other examples, the head-mounted device 1001 and/or audio output device 410 perform some or all of the tracking and computing.

In some examples, once the system 1000 has generated the spatial audio related to visual content 1002, the mobile device 601 transmits the spatial audio related to visual content 1002 to an audio output device 410. In some examples, the audio output device 410 is any of the audio output devices or earbuds described herein. In some examples, the audio output device 410 include one or more audio output devices to play spatial audio related to visual content 1002. In some examples, the audio output device 410 acts only as an audio output device and does not perform any calculations. In some other examples, the audio output device 410 tracks its own position throughout the three-dimensional environment 1004 and then send that information to the mobile device 601 for generation of the spatial audio. In some examples, the audio played at audio output device 410 can be spatial audio, stereo audio, or any other audio necessary to sound like the spatial audio is emanating from the visual content 1002 at the visual content location 1003. In some examples, the mobile device 601 performs all the computing for tracking the first orientation vector 1005. In other examples, the head-mounted device 1001 and/or audio output device 410 perform some or all of the tracking and computing

FIG. 10C illustrates the devices of the system 1000 in a three-dimensional environment 1004. In some examples, the system 1000 displays visual content 1002 at a visual content location 1003 to a user via the head-mounted device 1001 while also playing the spatial audio related to the visual content 1002 simulated as though playing from a respective location 1006. Respective location 1006 represents a location the spatial audio is simulated as playing from. Although FIG. 10C shows one respective location 1006, some embodiments include spatial audio that simulates a plurality of sound sources in the three-dimensional environment 1004. In some examples, the respective location 1006 and visual content location 1003 overlap (e.g., are the same, have the same origin, or have another location in common), thus the spatial audio sounds to the user like it emanates from the same location in the three-dimensional environment 1004 at which the visual content 1002 is located. In some examples, the mobile device 601 performs all the computing of the respective location 1006. In other examples, the head-mounted device 1001 and/or audio output device 410 perform some or all of the computing and localization. In some examples, the system 1000 tracks a second orientation vector of the audio output device 410 and transmits the spatial audio to the audio output device 410 for playback using the second orientation vector. In some examples, the mobile device 601 performs all the computing of tracking the second orientation vector. In other examples, the audio output device 410 and/or head-mounted perform some or all of the computing and tracking. The second orientation vector corresponds to a second forward direction of the audio output device 410 and is any orientation vector described herein that tracks the movement of the audio output device 410, unlike the first orientation vector 1005 which tracks the forward direction of the head-mounted device 1001. In some examples, when both the head-mounted device 1001 and audio output device 410 are worn by a user, the first orientation vector 1005 and the second orientation vector will be the same or will have an orientation relative to each other that is known and/or constant. Therefore, in some examples, rather than the mobile device 601 using the second orientation vector or both vectors to generate and transmit the spatial audio, the mobile device 601 only uses the first orientation vector 1005 since the vector of the head-mounted device 1001 more accurately represents the position of the user. In other examples, the mobile device 601 is configured to receive, from the audio output device 410, a second orientation vector of the audio output device 410, and then transmit the spatial audio back to the audio output device 410 for playback based on the second orientation vector. In some examples, both the first orientation vector 1005 and second orientation vector are used to generate and transmit the spatial audio.

In some examples, the system 1000 transmits the spatial audio related to the visual content 1002 to the audio output device 410 for playback simulating that the spatial audio is playing from a respective location 1006. In some examples, respective location 1006 corresponds to a specific location in three-dimensional environment 1004. In some examples, respective location 1006 is one or more locations representing the locations the spatial audio sounds like it emanates from. In some examples, respective location 1006 overlaps visual content location 1003 as described above. For example, in FIG. 10C, the “X” represents respective location 1006. In some examples, respective location 1006 differs slightly from visual content location 1003. Further, in some examples and in accordance with a determination that the visual content location 1003 is a first location in the virtual environment, respective location 1006 is associated with the first location in the virtual environment. Furthermore, in some other examples and in accordance with a determination that the visual content location 1003 is a second location in the virtual environment, different from the first location in the virtual environment, the respective location 1006 is associated with (e.g., overlaps as described above) the second location in the virtual environment. Thus, the mobile device 601 transmits the spatial audio for playback that simulates the audio emanating from a respective location 1006 in accordance with a determination that the respective location 1006 is associated with a location in an environment related to the visual content location 1003. In some examples, the mobile device 601 performs all the computing and transmitting, while in other examples, the head-mounted device 1001 and/or audio output device 410 perform some or all of the computing.

Spatial audio related to the visual content 1002, in some examples, is transmitted to the second electronic device 410 in response to the system 1000 detecting that the audio output device 410 is worn on the head of a user. In some other examples, transmitting the spatial audio to the audio output device 410 is initiated by the mobile device 601 detecting that the audio output device 410 are turned on. In some examples, transmitting the spatial audio to the audio output device 410 is initiated by the mobile device 601 detecting that the audio output device 410 has been connected via Bluetooth. Other examples that can initiate the transmittal of the spatial audio to the audio output device 410 include detecting that both the head-mounted device 1001 and the audio output device 410 are on, when both the head-mounted device 1001 and audio output device 410 are connected to the mobile device 601, etc. In some examples, the mobile device 601 performs all the computing. In other examples, the head-mounted device 1001 and/or audio output device 410 perform some or all of the computing.

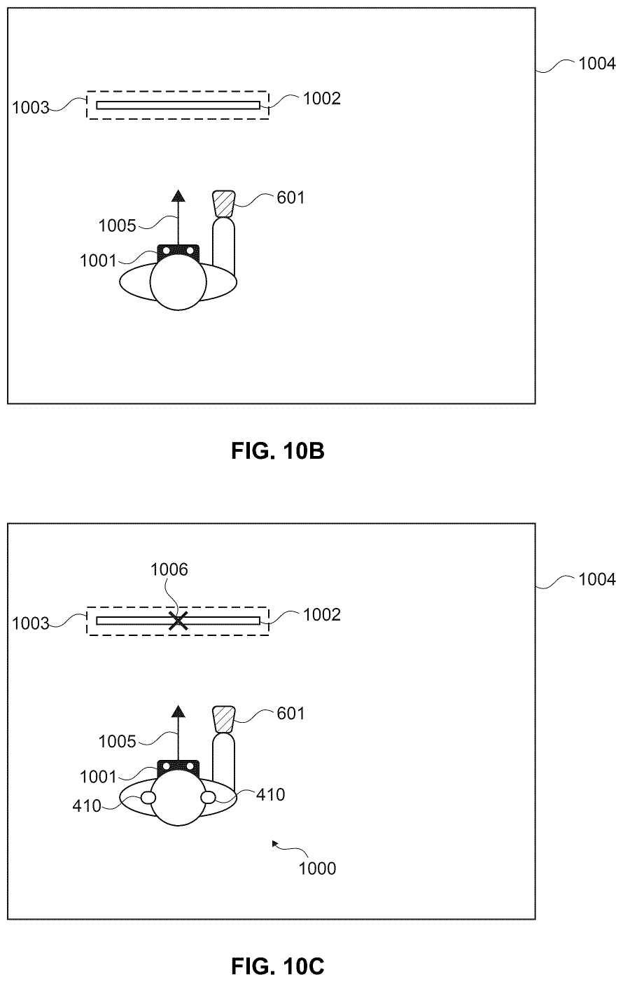

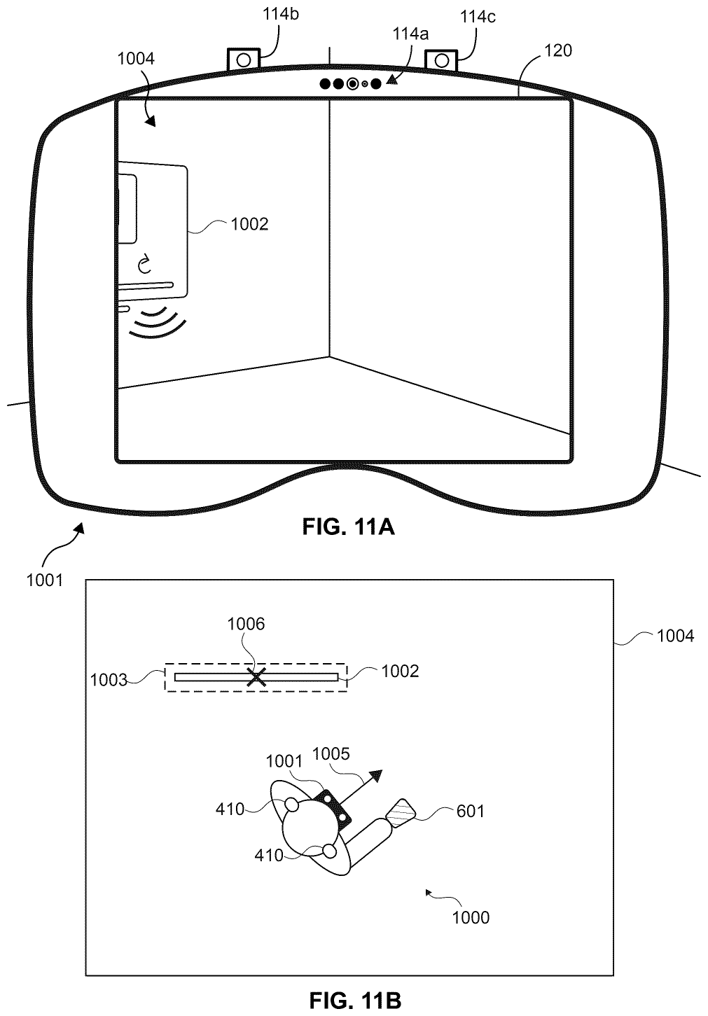

FIGS. 11A and 11B illustrate the head-mounted device 1001 displaying visual content 1002 and a bird's eye view of the three-dimensional environment 1004 FIG. after movement of the head-mounted device 1001 from the location of the head-mounted device 1001 in FIGS. 10A-10C.

FIG. 11A illustrates the head-mounted device 1001 displaying visual content 1002 in visual content location 1003 after the head-mounted device 1001 has moved in the three-dimensional environment 1004. In some examples, the mobile device 601 tracks, or updates, first orientation vector 1005 so that the spatial audio corresponding to the visual content 1002 is simulated as playing from the visual content location as the head-mounted device 1001 moves around a physical environment (e.g., and the three-dimensional environment 1004). In some examples, the head-mounted device 1001 moving around the three-dimensional environment 1004 includes the user moving with the head-mounted device 1001 in the physical environment. In some examples, both the head-mounted device 1001 and the audio output device 410 move together throughout the three-dimensional environment 1004 when both are worn on the head of a user. Though the devices and user move, the visual content location 1003 stays consistent relative to the three-dimensional environment, as shown by the change in viewpoint on display 120 in FIG. 11A. Thus, the method described herein is a continuous process to account for movement of the head-mounted device 1001 and audio output device 410 in the physical environment (e.g., three-dimensional environment 1004).

Furthermore, in some examples, the head-mounted device 1001 includes any sort of camera described herein to aid in tracking the movements around the three-dimensional environment and to consistently stream the virtual content from the same location in the three-dimensional environment irrespective of movement of the user relative to the three-dimensional environment.

In some examples, as shown in FIG. 11A, visual content 1002 is partially displayed on the display of the head-mounted device 1001 but the system 1000 still performs playback of the spatial audio to simulate the audio emanating from respective location 1006 related to the visual content location 1003. In some examples, visual content 1002 is out of frame of the viewpoint on the display but the system 1000 still presents the spatial audio to simulate the audio emanating from the same location (e.g., the respective location 1006) relative to the three-dimensional environment. In some examples, visual content 1002 existing out of the frame of the display on the head-mounted device 1001 in the three-dimensional environment is not the same as ceasing display of the visual content 1002. In some examples, the head-mounted device 1001 ceases displaying the visual content 1002. In some examples, ceasing displaying the visual content 1002 means the visual content 1002 is no longer included in the three-dimensional environment 1004. In some examples, the system 1000 ceases display of visual content 1002 in response to detecting any action of the user to intentionally cease display of visual content 1002 on the head-mounted device 1001. In some examples, the system 1000 ceases display of visual content 1002 in response to receiving a user input at the mobile device 601 to cease display of visual content 1002. In some examples, the system 1000 ceases display of visual content 1002 in response to receiving a user input at the head-mounted device 1001 to cease display of visual content 1002. In some examples, the system 1000 ceases display of visual content 1002 in response to detecting doff at the head-mounted device 1001. In some examples, the system 1000 ceases display of visual content 1002 in response to detecting a user input at the audio output device 410. In response to detecting that the head-mounted device 1001 has ceased displaying the visual content 1002 in the virtual environment, the system 1000 ceases to transmit the spatial audio to the audio output device 410. Instead, in some examples, the system 1000 transmits stereo audio to the audio output device 410. In some examples, the mobile device 601 performs all the computing. In other examples, the head-mounted device 1001 and/or audio output device 410 perform some or all of the computing.

FIG. 11B illustrates a bird's eye view of the same three-dimensional environment 1004 as FIG. 10C but the head-mounted device 1001 has moved in the physical environment. In this example, as explained above, the head-mounted device 1001 and audio output device 410 move together since both are worn on a user and move as a cluster. In some examples, when the devices move as a cluster, the mobile device 601 syncs the head-mounted device 1001 as the “ground truth” location, meaning the audio output device 410 relies on the orientation and frame of reference of the head-mounted device 1001 to simulate the spatial audio. As the one or more devices change location in the three-dimensional environment 1004, visual content location 1003 and respective location 1006 stay the same (e.g., both at the same location) and remain rigidly stationary. In some examples, visual content location 1003 and respective location 1006 overlap locations rather than being at the same location. In this example, the system 1000 presents the spatial audio to simulate the spatial audio emanating from a point in the three-dimensional environment 1004, but a three-dimensional object might take up a volume of space bigger than a point (e.g., the visual content 1002 is larger than one, singular point location and spans over multiple location points in the environment). Thus, the system 1000 presents the spatial audio to simulate the spatial audio as emanating from multiple points (e.g., an area of space in three-dimensional environment 1004) included in the volume of the visual content 1002. In some examples, visual content location 1003 refers to an area of three-dimensional environment 1004 rather than a specific point.

In some examples, mobile device 601 uses the first orientation vector 1005 to detect movement of the head-mounted device 1001. As shown in FIG. 11B, first orientation vector 1005 now points in a different direction than previously shown in FIG. 10C. This change in the angular direction of the head-mounted device 1001 is then used by the mobile device 601 to help spatialize the spatial audio at the same respective location 1006. In some examples, mobile device 601 also tracks a distance between the head-mounted device 1001 and the respective location 1006. For example, as the head-mounted device 1001 moves closer to the respective location 1006 (e.g., the visual content location 1003), mobile device 601 increases the volume of the spatial audio. In another example, as the head-mounted device 1001 moves farther away from the respective location 1006 (e.g., the visual content location 1003), mobile device 601 decreases the volume of the spatial audio.

In some examples, the mobile device 601 detects a difference between the visual content location 1003 and respective location 1006. For example, when there is a large, sharp movement of the head-mounted device 1001, there may be a delay before the mobile device 601 resets, which can cause drift between the locations in the three-dimensional environment of the visual content 1002 and the location in the three-dimensional environment the spatial audio is simulated as emanating from (e.g., visual content location 1003 and respective location 1006). For example, a large, sharp movement includes dropping the head-mounted device 1001. In some examples, a large, sharp movement includes a user turning their head very fast or moving very quickly while wearing the head-mounted device 1001. In some examples, and in accordance with a determination that the difference is greater than a threshold amount (e.g., exceeds the threshold), the mobile device 601 adjusts the visual content location 1003 and/or the respective location 1006 of the spatial audio in accordance with the difference. In some examples, the threshold amount refers to a numerical value representing the distance (e.g., drift) between the visual content location 1003 and the respective location 1006, or drift between a previous spatial relationship between the visual content location 1003 and the respective location 1006 and the current spatial relationship between the visual content location 1003 and the respective location 1006. For example, in response to detecting the drift distance exceeds the threshold, the mobile device 601 adjusts the visual content location 1003. For example, in response to detecting the drift distance exceeds the threshold, the mobile device 601 adjusts the respective location 1006. For example, in response to detecting the drift distance exceeds the threshold, the mobile device 601 adjusts the visual content location 1003 and the respective location 1006. For example, in response to detecting the drift distance does not exceed the threshold (e.g., below the threshold), the mobile device 601 does not adjust either location. In some examples, mobile device 601 will readjust the drift as the mobile device 601 continuously generates the spatial audio.

In some examples, audio output device 410 is a stationary device. For example, the audio output device 410 is one or more speakers that stay stationary in three-dimensional environment 1004 (e.g., does not move with the user) while the head-mounted device 1001 is mobile (e.g., moves with the user). In this example, mobile device 601 knows the stationary location of audio output device 410 and uses that stationary location as well as the visual content location 1003 and first orientation vector 1005 to generate the spatial audio.

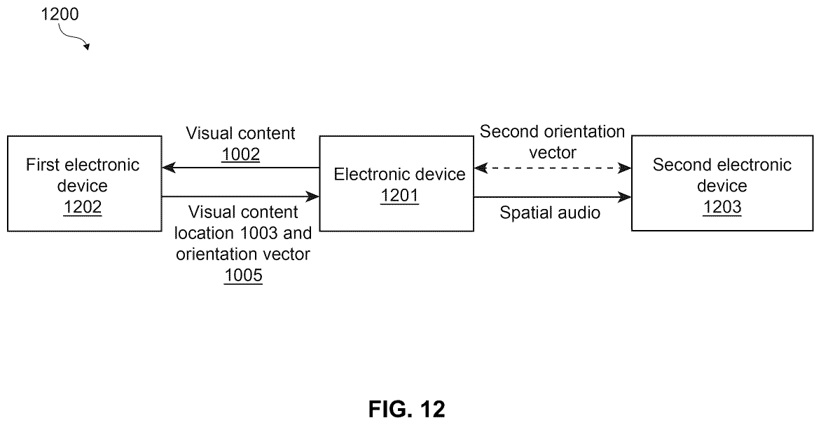

FIG. 12 is an example block diagram that illustrates the communication between a system 1200 corresponding to system 1000 and including an example electronic device 1201, first electronic device 1202, and second electronic device 1203. As used herein, electronic device 1201 corresponds to mobile device 601, first electronic device 1202 corresponds to a head-mounted device 1001, and second electronic device 1203 corresponds to audio output device 410. The process described above for synchronization of locations in the three-dimensional environment of visual content to spatial audio between multiple devices is performed at the system 1200. In some examples, electronic device 1201 performs the computing and transmits the visual content 1002 to the first electronic device 1202 to display using the one or more displays 120. While transmitting the visual content 1002 to the first electronic device 1202, in some examples, electronic device 1201 receives the visual content location 1003 and first orientation vector 1005 from the first electronic device 1202. Furthermore, in some examples, the electronic device 1201 receives the second orientation vector, or the positional location of the second electronic device 1203, from second electronic device 1203. In some other examples, electronic device 1201 tracks the second orientation vector and sends the information to the second electronic device 1203. Lastly, electronic device 1201 is configured to transmit the spatial audio to the second electronic device 1203 for playback at the one or more audio output devices.

Some examples described herein refer to a system comprising a first electronic device 1202 configured to display visual content 1002 at a visual content location 1003 via one or more displays 120. First electronic device 1202 refers to a head-mounted device 1001. In some examples, the system further includes a second electronic device 1203 configured to play spatial audio related to the visual content 1002 via one or more audio output devices. Second electronic device 1203 refers to an audio output device 410, such as headphones or earbuds. In some examples, an electronic device 1201 is configured to transmit the spatial audio related to the visual content 1002 to the second electronic device 1203 for playback of the spatial audio at the one or more audio output devices simulating that the spatial audio is playing from a respective location 1006. In accordance with a determination that the visual content location 1003 is a first location in the virtual environment, the respective location 1006 is associated with the first location in the virtual environment. In accordance with a determination that the visual content location 1003 is a second location in the virtual environment different from the first location in the virtual environment, the respective location 1006 is associated with the second location in the virtual environment. Third electronic device corresponds to electronic device 1201, which refers to a mobile device 601 configured to perform all the processing steps described herein. For example, the first electronic device 1202 sends information pertaining to its position and location to the electronic device 1201, which then uses that data to perform audio computing and transmit that audio the second electronic device 1203, as shown in FIG. 12.

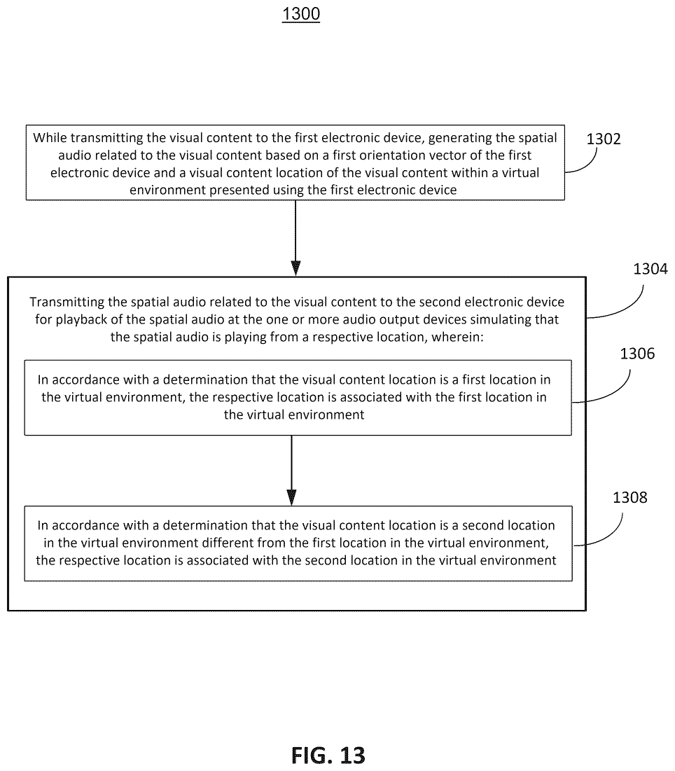

FIG. 13 illustrates a flow diagram illustrating an example process for synchronization of visual content to spatial audio between multiple devices according to some examples of the disclosure. In some examples, process 1300 is performed at electronic device 1201 while electronic device 1201 is in communication with first electronic device 1202 and/or second electronic device 1203 described above with reference to FIG. 12. In some examples, process 1300 is performed by multiple devices included in system 1000, including electronic device 1201, first electronic device 1202, and/or second electronic device 1203 described above with reference to FIG. 12. In some examples, as shown in FIGS. 10A-C, the electronic device 1201 is a mobile device 610, the first electronic device 1202 is a head-mounted device 1001, and second electronic device 1203 is an audio output device 410 (e.g., headphones, earbuds, or speakers). In some examples, at 1302, while transmitting the visual content 1002 to the first electronic device 1001, one or more devices of system 1000 generates the spatial audio related to the visual content 1002 based on first orientation vector 1005 of the first electronic device 1202 and a visual content location 1003 of the visual content 1002 within a virtual environment presented using the first electronic device 1202, as shown in FIGS. 10B-11B. In some examples, visual content 1002 is any media content that includes spatial audio. In some examples, the first orientation vector 1005 corresponds to a first forward direction of the first electronic device 1202. Further, in some examples, one or more devices of system 1000 updates the first orientation vector 1005 in response to movement of the first electronic device 1202 so that the spatial audio is simulated as playing from the visual content location 1003 in a physical environment (e.g., three-dimensional environment 1004).

In some examples, at 1304, one or more devices of system 1000 transmits the spatial audio related to the visual content 1002 to the second electronic device 1203 for playback of the spatial audio at the one or more audio output devices simulating that the spatial audio is playing from a respective location 1006. In some examples, as shown in FIGS. 10C and 11B, the respective location 1006 and the visual content location 1003 are the same. At 1306, in some examples, in accordance with a determination that the visual content location 1003 is a first location in the virtual environment, the respective location 1006 is associated with the first location in the virtual environment. At 1308, in some examples, in accordance with a determination that visual content location 1003 is a second location in the virtual environment different from the first location in the virtual environment, the respective location 1006 is associated with the second location in the virtual environment. In some examples, one or more devices of system 1000 transmit the spatial audio related to the visual content 1002 to the second electronic device 1203 in response to detecting that the second electronic device 1203 is worn on a user. In some examples, process 1300 includes one or more devices of system 1000 detecting that the first electronic device 1202 has ceased displaying the visual content 1002 in the virtual environment and, in response to detecting that the first electronic device 1202 has ceased displaying the visual content 1002 in the virtual environment, one or more devices of system 1000 ceases to transmit the spatial audio to the second electronic device 1203 and transmitting stereo audio to the second electronic device 1203. In some examples, process 1300 includes one or more devices of system 1000 detecting a difference between the visual content location 1003 and the respective location 1006 of the spatial audio and, in accordance with a determination that the difference is greater than a threshold amount, adjusting the visual content location 1003 and/or the respective location 1006 of the spatial audio in accordance with the difference.

Further, in some examples, one or more devices of system 1000 optionally tracks a second orientation vector of the second electronic device 1203. In some examples, one or more devices of system 1000 optionally transmits the spatial audio related to the visual content 1002 to the second electronic device 1203 for playback of the spatial audio using the second orientation vector. In some examples, one or more devices of system 1000 tracks the orientation of the second electronic device 1203 to spatialize the audio, rather than the second electronic device 1203 tracking their own orientation.

Furthermore, in some examples, one or more devices of system 1000 optionally receives, from the second electronic device 1203, a second orientation vector of the second electronic device 1203. In some examples, one or more devices of system 1000 optionally transmits the spatial audio related to the visual content 1002 to the second electronic device 1203 for playback of the spatial audio using the second orientation vector. In some examples, the second electronic device 1203 tracks its own orientation and transmit the information to the electronic device 1201 to spatialize the audio, rather than electronic device 1201 tracking the orientation of the second electronic device 1203.

Therefore, according to the above, some examples of the disclosure are directed to a method at a first electronic device including one or more first audio output devices configured for communication with a second electronic device including one or more second audio output devices: while the first electronic device is performing playback of spatial audio via the one or more first audio output devices corresponding to one or more first locations within a three-dimensional environment, receiving an indication to transfer the spatial audio to the one or more second audio output devices; determining an offset between a first orientation vector of the first electronic device and a second orientation vector received from the second electronic device; in accordance with a determination that one or more criteria are satisfied, generating the spatial audio using the second orientation vector and the offset between the first orientation vector and the second orientation vector, and the spatial audio; in accordance with a determination that the one or more criteria are not satisfied, generating the spatial audio using the first orientation vector; and in response to receiving the indication to transfer the spatial audio to the one or more second audio output devices, transmitting, the spatial audio to the second electronic device and initiate playback of the spatial audio using the one or more second audio output devices at one or more second locations within the three-dimensional environment corresponding to the one or more first locations within the three-dimensional environment.

Additionally or alternatively, in some examples, the first orientation vector corresponds to a forward direction of the first electronic device, and the second orientation vector corresponds to a forward direction of the second electronic device. Additionally or alternatively, in some examples, the offset between the first orientation vector and the second orientation vector is determined when first electronic device initiates the playback of the spatial audio or when an application that plays spatial audio is launched. Additionally or alternatively, in some examples, the offset between the first orientation vector and the second orientation vector is determined when the second electronic device is paired to the first electronic device. Additionally or alternatively, in some examples, the offset between the first orientation vector and the second orientation vector is determined before the indication is received. Additionally or alternatively, in some examples, the offset between the first orientation vector and the second orientation vector is determined when the indication is received. Additionally or alternatively, in some examples, the first electronic device includes one or more input devices, including one or more cameras. The spatial audio is generated based on physical objects in the three-dimensional environment. Additionally or alternatively, in some examples, the first electronic device includes one or more input devices and data from the one or more input devices provides indications of locomotion and/or head movement of a user. Additionally or alternatively, in some examples, one or more criteria include a criterion that is satisfied when the first electronic device is detected as worn by a user. Additionally or alternatively, in some examples, the one or more criteria include a criterion that is satisfied when the second electronic device is detected as worn by a user. Additionally or alternatively, in some examples, the one or more criteria include a criterion that is satisfied when a battery level of the first electronic device is below a battery level threshold. Additionally or alternatively, in some examples, one or more second locations within the three-dimensional environment are the same as the one or more first locations within the three-dimensional environment. Additionally or alternatively, in some examples, the spatial audio is generated based on a mapping of the three-dimensional environment obtained from memory of the first electronic device. Additionally or alternatively, in some examples, the indication to transfer the spatial audio to the one or more second audio output devices includes detecting a doff of the first electronic device. Additionally or alternatively, in some examples, the first electronic device continues performing the playback of the spatial audio, via the one or more first audio output devices, concurrently with the playback of the spatial audio, via the one or more second audio output devices.

Some examples of the disclosure are directed to a method comprising, at an electronic device configured for communication with a first electronic device including one or more first audio output devices and a second electronic device including one or more second audio output devices: receiving a first indication to initiate playback of spatial audio using the one or more first audio output devices; in response to the first indication: generating the spatial audio using a first orientation vector of the first electronic device obtained from the first electronic device; and transmitting the spatial audio to the first electronic device for playback of the spatial audio using the one or more first audio output devices at one or more first locations within a three-dimensional environment; receiving a second indication to initiate playback of spatial audio using the one or more second audio output devices; in response to the second indication, in accordance with a determination that one or more criteria are satisfied: generating the spatial audio using a second orientation vector of the first electronic device obtained from the first electronic device and an offset between the first orientation vector of the first electronic device and the second orientation vector received from the second electronic device; and transmitting the spatial audio to the second electronic device for playback of the spatial audio using the one or more second audio output devices at one or more second locations within the three-dimensional environment corresponding to the one or more first locations within the three-dimensional environment.

Additionally or alternatively, in some examples, the first orientation vector corresponds to a forward direction of the first electronic device, and the second orientation vector corresponds to a forward direction of the second electronic device. Additionally or alternatively, in some examples, the offset between the first orientation vector and the second orientation vector is determined when first electronic device initiates the playback of the spatial audio or when an application that plays spatial audio is launched at the first electronic device. Additionally or alternatively, in some examples, the offset between the first orientation vector and the second orientation vector is determined when the second electronic device is paired to the first electronic device. Additionally or alternatively, in some examples, the offset between the first orientation vector and the second orientation vector is determined before the second indication is received. Additionally or alternatively, in some examples, the offset between the first orientation vector and the second orientation vector is determined when the second indication is received. Additionally or alternatively, in some examples, the first electronic device includes one or more input devices including one or more cameras, the method further comprising: generating the spatial audio based on physical objects in the three-dimensional environment obtained from the first electronic device via the one or more input devices. Additionally or alternatively, in some examples, the first electronic device includes one or more input devices and data from the one or more input devices provides indications of locomotion and/or head movement of a user. Additionally or alternatively, in some examples, one or more criteria include a criterion that is satisfied when the first electronic device is detected as worn by a user. Additionally or alternatively, in some examples, the one or more criteria include a criterion that is satisfied when the second electronic device is detected as worn by a user. Additionally or alternatively, in some examples, the one or more criteria include a criterion that is satisfied when a battery level of the first electronic device is below a battery level threshold. Additionally or alternatively, in some examples, one or more second locations within the three-dimensional environment are the same as the one or more first locations within the three-dimensional environment. Additionally or alternatively, in some examples, the spatial audio is generated based on a mapping of the three-dimensional environment obtained from memory of the electronic device or the first electronic device. Additionally or alternatively, in some examples, the second indication includes detecting a doff of the first electronic device. Additionally or alternatively, in some examples, the first electronic device continues performing the playback of the spatial audio, via the one or more first audio output devices, concurrently with the playback of the spatial audio, via the one or more second audio output devices.

Therefore, according to the above, some examples of the disclosure are directed to a method at an electronic device configured to communicate with a first electronic device including one or more displays to display visual content and a second electronic device including one or more audio output devices to play spatial audio related to the visual content: while transmitting the visual content to the first electronic device: generating the spatial audio related to the visual content based on a first orientation vector of the first electronic device and a visual content location of the visual content within a virtual environment presented using the first electronic device; and transmitting the spatial audio related to the visual content to the second electronic device for playback of the spatial audio at the one or more audio output devices simulating that the spatial audio is playing from a respective location, wherein: in accordance with a determination that the visual content location is a first location in the virtual environment, the respective location is associated with the first location in the virtual environment, and in accordance with a determination that the visual content location is a second location in the virtual environment different from the first location in the virtual environment, the respective location is associated with the second location in the virtual environment.

Additionally or alternatively, in some examples, the first orientation vector corresponds to a first forward direction of the first electronic device. Additionally or alternatively, in some examples, the electronic device updates the first orientation vector in response to movement of the first electronic device within a physical environment. Additionally or alternatively, in some examples, transmitting the spatial audio related to the visual content to the second electronic device is in response to detecting that the second electronic device is worn on a user. Additionally or alternatively, in some examples, the method further comprises obtaining a second orientation vector of the second electronic device wherein generating the spatial audio related to the visual content is further based on the second orientation vector. Additionally or alternatively, in some examples, the method further comprises detecting that the first electronic device has ceased displaying the visual content in the virtual environment and in response to detecting that the first electronic device has ceased displaying the visual content in the virtual environment: ceasing to transmit the spatial audio to the second electronic device and transmitting stereo audio to the second electronic device. Additionally or alternatively, in some examples, the method further comprises detecting a difference between the visual content location and the respective location of the spatial audio and in accordance with a determination that the difference is greater than a threshold amount, adjusting the visual content location and/or the respective location of the spatial audio in accordance with the difference. Additionally or alternatively, in some examples, the visual content is media content that includes spatial audio.

Some examples of the disclosure are directed to a system comprising: a first electronic device configured to display visual content at a visual content location via one or more displays; a second electronic device configured to play spatial audio related to the visual content via one or more audio output devices; and a third electronic device configured to transmit the spatial audio related to the visual content to the second electronic device for playback of the spatial audio at the one or more audio output devices simulating that the spatial audio is playing from a respective location, wherein: in accordance with a determination that the visual content location is a first location in the virtual environment, the respective location is associated with the first location in the virtual environment, and in accordance with a determination that the visual content location is a second location in the virtual environment different from the first location in the virtual environment, the respective location is associated with the second location in the virtual environment.

Some examples of the disclosure are directed to an electronic device, comprising: one or more processors; memory; and one or more programs stored in the memory and configured to be executed by the one or more processors, the one or more programs including instructions for performing any of the above methods.

Some examples of the disclosure are directed to a non-transitory computer-readable storage medium storing one or more programs, the one or more programs comprising instructions, which when executed by one or more processors of an electronic device, cause the electronic device to perform any of the above methods.

Some examples of the disclosure are directed to an electronic device, comprising one or more processors, memory, and means for performing any of the above methods.

Some examples of the disclosure are directed to an information processing apparatus for use in an electronic device, the information processing apparatus comprising means for performing any of the above methods.

The foregoing description, for purpose of explanation, has been described with reference to specific examples. However, the illustrative discussions above are not intended to be exhaustive or to limit the disclosure to the precise forms disclosed. Many modifications and variations are possible in view of the above teachings. The examples were chosen and described in order to best explain the principles of the disclosure and its practical applications, to thereby enable others skilled in the art to best use the disclosure and various described examples with various modifications as are suited to the particular use contemplated.

Although examples of this disclosure have been fully described with reference to the accompanying drawings, it is to be noted that various changes and modifications will become apparent to those skilled in the art. Such changes and modifications are to be understood as being included within the scope of examples of this disclosure as defined by the appended claims.

1. A method comprising:
at a first electronic device including one or more first audio output devices configured for communication with a second electronic device including one or more second audio output devices:
while the first electronic device is performing playback of spatial audio via the one or more first audio output devices corresponding to one or more first locations within a three-dimensional environment, receiving an indication to transfer the spatial audio to the one or more second audio output devices;
determining an offset between a first orientation vector of the first electronic device and a second orientation vector received from the second electronic device;
in accordance with a determination that one or more criteria are satisfied, generating the spatial audio using the second orientation vector and the offset between the first orientation vector and the second orientation vector;
in accordance with a determination that the one or more criteria are not satisfied, generating the spatial audio using the first orientation vector; and
in response to receiving the indication to transfer the spatial audio to the one or more second audio output devices, transmitting the spatial audio to the second electronic device for playback using the one or more second audio output devices at one or more second locations within the three-dimensional environment corresponding to the one or more first locations within the three-dimensional environment.

2. The method of claim 1, wherein the first orientation vector corresponds to a forward direction of the first electronic device, and the second orientation vector corresponds to a forward direction of the second electronic device.

3. The method of claim 1, wherein the offset between the first orientation vector and the second orientation vector is determined when first electronic device initiates the playback of the spatial audio or when an application that plays spatial audio is launched.

4-6. (canceled)

7. The method of claim 1, wherein the first electronic device includes one or more input devices, including one or more cameras, and wherein the spatial audio is generated based on physical objects in the three-dimensional environment.

8-10. (canceled)

11. The method of claim 1, wherein the one or more criteria include a criterion that is satisfied when a battery level of the first electronic device is below a battery level threshold.

12. The method of claim 1, wherein one or more second locations within the three-dimensional environment are the same as the one or more first locations within the three-dimensional environment.

13. The method of claim 1, wherein the spatial audio is generated based on a mapping of the three-dimensional environment obtained from memory of the first electronic device.

14. (canceled)

15. The method of claim 1, wherein the first electronic device continues performing the playback of the spatial audio, via the one or more first audio output devices, concurrently with the playback of the spatial audio, via the one or more second audio output devices.

16-45. (canceled)

46. A first electronic device, comprising:
a display;
one or more input devices;
one or more processors;
one or more first audio output devices configured for communication with a second electronic device including one or more second audio output devices;
non-transitory memory; and
one or more programs, wherein the one or more programs are stored in the non-transitory memory and configured to be executed by the one or more processors, the one or more programs including instructions that cause the first electronic device to perform:
while the first electronic device is performing playback of spatial audio via the one or more first audio output devices corresponding to one or more first locations within a three-dimensional environment, receiving an indication to transfer the spatial audio to the one or more second audio output devices;
determining an offset between a first orientation vector of the first electronic device and a second orientation vector received from the second electronic device;
in accordance with a determination that one or more criteria are satisfied, generating the spatial audio using the second orientation vector and the offset between the first orientation vector and the second orientation vector;
in accordance with a determination that the one or more criteria are not satisfied, generating the spatial audio using the first orientation vector; and
in response to receiving the indication to transfer the spatial audio to the one or more second audio output devices, transmitting the spatial audio to the second electronic device for playback using the one or more second audio output devices at one or more second locations within the three-dimensional environment corresponding to the one or more first locations within the three-dimensional environment.

47. The first electronic device of claim 46, wherein the first orientation vector corresponds to a forward direction of the first electronic device, and the second orientation vector corresponds to a forward direction of the second electronic device.

48. The first electronic device of claim 46, wherein the offset between the first orientation vector and the second orientation vector is determined when first electronic device initiates the playback of the spatial audio or when an application that plays spatial audio is launched.

49. The first electronic device of claim 46, wherein the first electronic device includes one or more input devices, including one or more cameras, and wherein the spatial audio is generated based on physical objects in the three-dimensional environment.

50. The first electronic device of claim 46, wherein the one or more criteria include a criterion that is satisfied when a battery level of the first electronic device is below a battery level threshold.

51. The first electronic device of claim 46, wherein one or more second locations within the three-dimensional environment are the same as the one or more first locations within the three-dimensional environment.

52. The first electronic device of claim 46, wherein the spatial audio is generated based on a mapping of the three-dimensional environment obtained from memory of the first electronic device.

53. The first electronic device of claim 46, wherein the first electronic device continues performing the playback of the spatial audio, via the one or more first audio output devices, concurrently with the playback of the spatial audio, via the one or more second audio output devices.

54. A non-transitory computer-readable storage medium storing one or more programs, the one or more programs comprising instructions, which, when executed by a first electronic device with a display, one or more first audio output devices configured for communication with a second electronic device including one or more second audio output devices, and an input device, cause the first electronic device to perform:
while the first electronic device is performing playback of spatial audio via the one or more first audio output devices corresponding to one or more first locations within a three-dimensional environment, receiving an indication to transfer the spatial audio to the one or more second audio output devices;
determining an offset between a first orientation vector of the first electronic device and a second orientation vector received from the second electronic device;
in accordance with a determination that one or more criteria are satisfied, generating the spatial audio using the second orientation vector and the offset between the first orientation vector and the second orientation vector;
in accordance with a determination that the one or more criteria are not satisfied, generating the spatial audio using the first orientation vector; and
in response to receiving the indication to transfer the spatial audio to the one or more second audio output devices, transmitting the spatial audio to the second electronic device for playback using the one or more second audio output devices at one or more second locations within the three-dimensional environment corresponding to the one or more first locations within the three-dimensional environment.

55. The non-transitory computer-readable storage medium of claim 54, wherein the first orientation vector corresponds to a forward direction of the first electronic device, and the second orientation vector corresponds to a forward direction of the second electronic device.

56. The non-transitory computer-readable storage medium of claim 54, wherein the offset between the first orientation vector and the second orientation vector is determined when first electronic device initiates the playback of the spatial audio or when an application that plays spatial audio is launched.

57. The non-transitory computer-readable storage medium of claim 54, wherein the first electronic device includes one or more input devices, including one or more cameras, and wherein the spatial audio is generated based on physical objects in the three-dimensional environment.

58. The non-transitory computer-readable storage medium of claim 54, wherein the one or more criteria include a criterion that is satisfied when a battery level of the first electronic device is below a battery level threshold.

59. The non-transitory computer-readable storage medium of claim 54, wherein one or more second locations within the three-dimensional environment are the same as the one or more first locations within the three-dimensional environment.

60. The non-transitory computer-readable storage medium of claim 54, wherein the spatial audio is generated based on a mapping of the three-dimensional environment obtained from memory of the first electronic device.

61. The non-transitory computer-readable storage medium of claim 54, wherein the first electronic device continues performing the playback of the spatial audio, via the one or more first audio output devices, concurrently with the playback of the spatial audio, via the one or more second audio output devices.
